(19) United States
(12) Patent Application Publication
(10) Pub. No.: US 2026/0030992 A1
(43) Pub. Date: Jan. 29, 2026

(54) SYSTEM AND METHOD FOR AUTONOMOUSLY GENERATING DIGITAL PROCEDURES AND PROCEDURE GUIDANCE WITHIN A FACILITY

(71) Applicant: Apprentice FS, Inc., Jersey City, NJ (US)

(72) Inventors: Frank Maggiore, Jersey City, NJ (US); Angelo Stracquatanio, Jersey City, NJ (US); Quoc Duong, Jersey City, NJ (US); Michael Keels, Jersey City, NJ (US); Emilee Cook, Jersey City, NJ (US); Younge Qu, Jersey City, NJ (US)

(21) Appl. No.: 19/347,580

(22) Filed: Oct. 1, 2025

Related U.S. Application Data
(63) Continuation-in-part of application No. 18/936,551, filed on Nov. 4, 2024.
Application No. 18/936,551 is a continuation-in-part of application No. 18/658,257, filed on May 8, 2024.
(63) Continuation-in-part of application No. 18/440,334, filed on Feb. 13, 2024.
Application No. 18/440,334 is a continuation-in-part of application No. 18/234,808, filed on Aug. 16, 2023, now Pat. No. 12,468,876.
(60) Provisional application No. 63/399,137, filed on Aug. 18, 2022.
(60) Provisional application No. 63/445,228, filed on Feb. 13, 2023.
(60) Provisional application No. 63/446,572, filed on Feb. 17, 2023.
(60) Provisional application No. 63/522,840, filed on Jun. 23, 2023.
(60) Provisional application No. 63/522,843, filed on Jun. 23, 2023.
(60) Provisional application No. 63/547,301, filed on Nov. 3, 2023.

(51) Int. Cl. G09B 5/02; G06F 40/40; G06V 20/40; G06V 20/52

(52) U.S. Cl. CPC G09B 5/02; G06F 40/40; G06V 20/44; G06V 20/46; G06V 20/52; G06V 2201/02; G06V 2201/06

(57) ABSTRACT

A method includes accessing a digital procedure performable within a facility. The method also includes, during performance of the digital procedure by an operator within the facility: accessing a data stream representing performance of the digital procedure by the operator; detecting a deviation from the digital procedure in the data stream; and, based on the deviation, predicting an anticipated batch yield expected upon completion of the digital procedure by the operator. The method further includes, in response to the anticipated batch yield falling outside of a target batch yield: based on natural language signals in the digital procedure, generating recovery instructions predicted to reduce a difference between the anticipated batch yield and the target batch yield defined in the digital procedure; and serving a prompt to the operator to suspend performance of the digital procedure and to complete the recovery instructions.

### CROSS-REFERENCE TO RELATED APPLICATIONS

This Application is a continuation-in-part of U.S. patent application Ser. No. 18/936,551, filed on 4 Nov. 2024, which claims the benefit of U.S. Provisional Application No. 63/547,301, filed on 3 Nov. 2023, each of which is incorporated in its entirety by this reference.

U.S. patent application Ser. No. 18/936,551 is also a continuation-in-part of U.S. patent application Ser. No. 18/658,257, filed on 8 May 2024, which claims the benefit of U.S. Provisional Application Nos. 63/522,840, filed on 23 Jun. 2023, and 63/522,843, filed on 23 Jun. 2023, each of which is hereby incorporated in its entirety by this reference.

This Application is also a continuation-in-part of U.S. patent application Ser. No. 18/440,334, filed on 13 Feb. 2024, which claims the benefit of U.S. Provisional Application Nos. 63/446,572, filed on 17 Feb. 2023, and 63/445,228, filed on 13 Feb. 2023, each of which is hereby incorporated in its entirety by this reference.

U.S. patent application Ser. No. 18/440,334 is also a continuation-in-part of U.S. patent application Ser. No. 18/234,808, filed on 16 Aug. 2023, which claims the benefit of U.S. Provisional Application No. 63/399,137, filed on 18 Aug. 2022, each of which is hereby incorporated in its entirety by this reference.

This Application is related to U.S. patents application Ser. No. 17/984,996, filed on 10 Nov. 2022, Ser. No. 17/719,120, filed on 12 Apr. 2022, and Ser. No. 18/204,837, filed on 1 Jun. 2023, each of which is hereby incorporated in its entirety by this reference.

### TECHNICAL FIELD

This invention relates generally to the field of manufacturing and, more specifically, to a new and useful method for automatically generating steps and guidance of a digital procedure within a manufacturing facility.

### BRIEF DESCRIPTION OF THE FIGURES

FIG. 1 is a flowchart representation of a method;

FIG. 2 is a flowchart representation of the method;

FIG. 3 is a flowchart representation of the method;

FIG. 4 is a flowchart representation of the method;

FIG. 5 is a flowchart representation of the method;

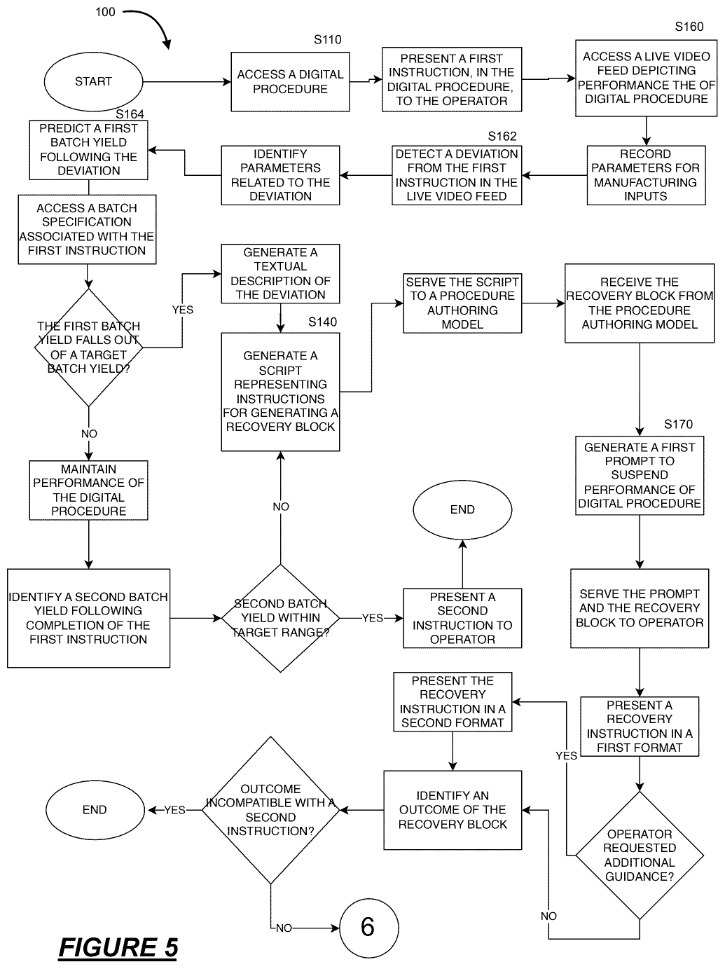

FIG. 6 is a flowchart representation of the method;

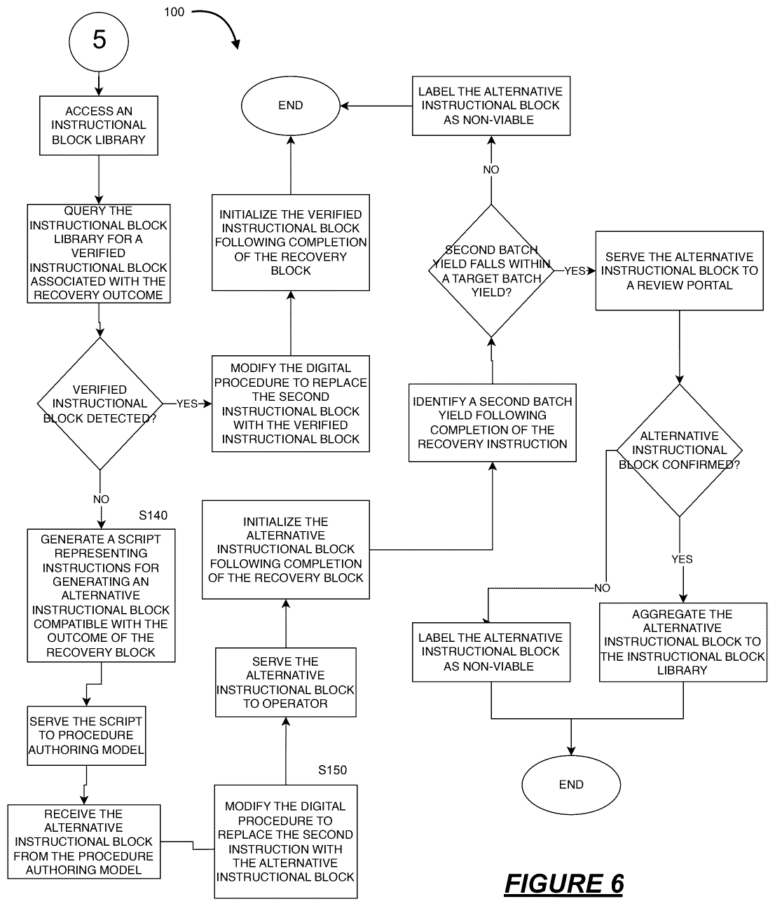

FIG. 7 is a flowchart representation of the method; and

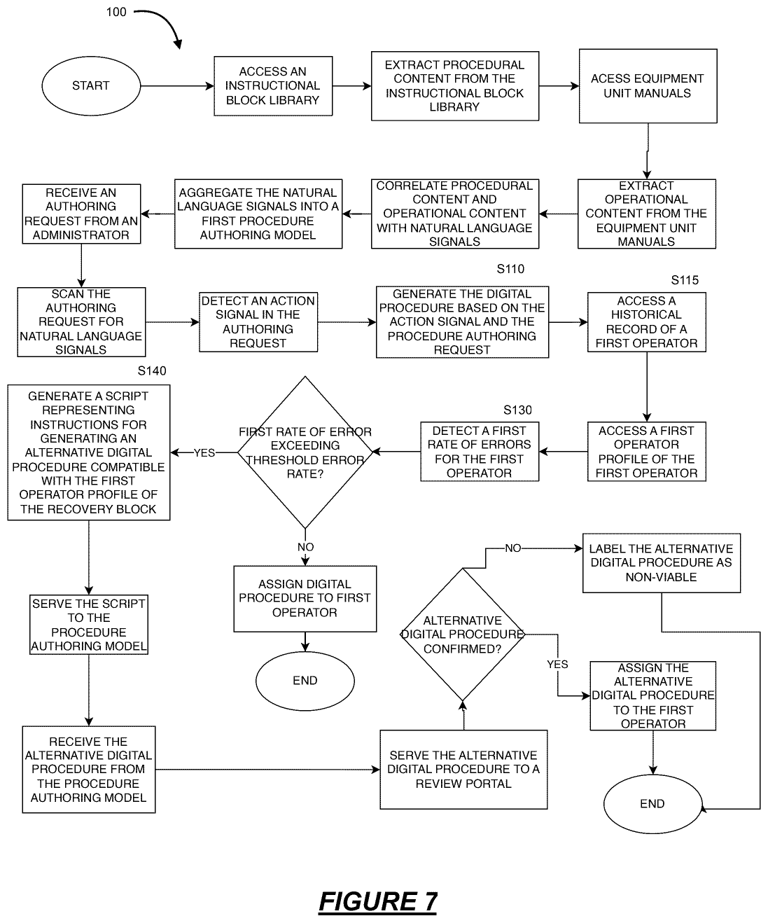

FIG. 8 is a flowchart representation of the method.

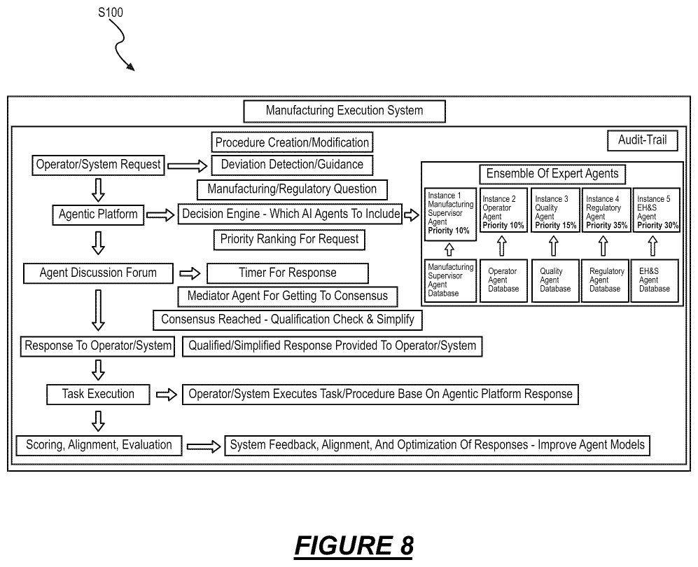

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method: Planned Recovery

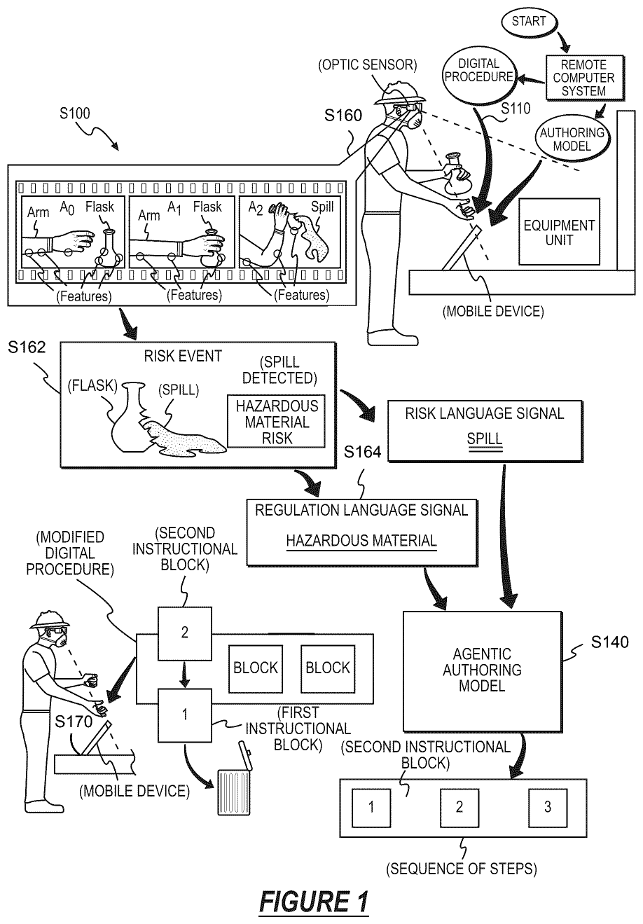

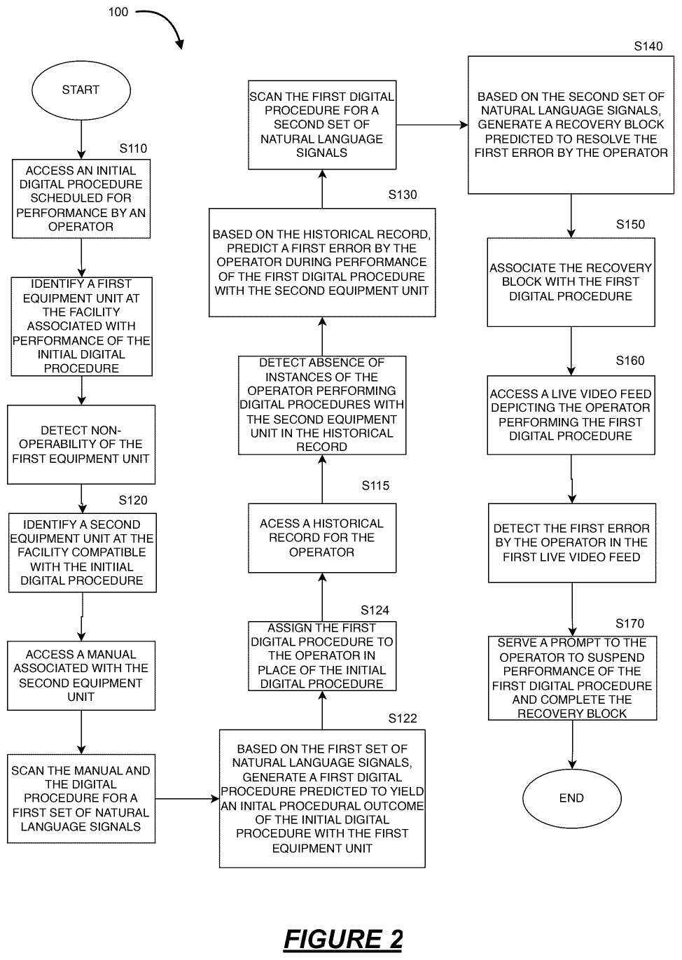

As shown in FIGS. 1 and 2, a method S100 includes: accessing a digital procedure including a sequence of instructional blocks performable within a facility in Block S110; and accessing a historical record of instances of digital procedures performed by an operator at the facility in Block S115.

The method S100 also includes, prior to performance of the digital procedure by the operator: based on the historical record, predicting a primary error by the operator during performance of a primary instructional block in the sequence of instructional blocks in the digital procedure in Block S130; based on a primary set of natural language signals in the primary instructional block, generating a primary recovery block predicted to reduce a difference between a primary anticipated procedural outcome of the primary instructional block resulting from the primary error and a target procedural outcome defined in the primary instructional block in Block S140; and associating the primary recovery block with the primary instructional block in Block S150.

The method S100 further includes, during performance of the primary instructional block by the operator: accessing a primary live video feed, captured by an optical sensor, depicting performance of the primary instructional block by the operator in Block S160; and, in response to detecting the primary error in the primary live video feed, serving a primary prompt to the operator to suspend performance of the primary instructional block and to complete the primary recovery block in Block S170.

### 1.1 Variation: Non-Operational Equipment Unit

As shown in FIGS. 1 and 2, a variation of the method S100 includes accessing a digital procedure including a set of instructional blocks performable within a facility in Block S110.

This variation of the method S100 also includes, in response to non-operability of a primary equipment unit related to performance of an initial instructional block in the set of instructional blocks in the digital procedure: identifying a secondary equipment unit available for operation within the facility and compatible with the initial instructional block in Block S120; based on an initial set of natural language signals in the initial instructional block, generating a primary instructional block predicted to yield an initial procedural outcome of initial primary instructional block with the secondary equipment unit in Block S122; and replacing the initial instructional block with the primary instructional block in the digital procedure in Block S124.

This variation of the method S100 further includes, prior to performance of the digital procedure by an operator: accessing a historical record of instances of digital procedures performed by the operator at the facility in Block S115; based on the historical record, predicting a primary error by the operator during performance of the primary instructional block with the secondary equipment unit in Block S130; based on a primary set of natural language signals in the primary instructional block, generating a primary recovery block predicted to reduce a difference between a primary procedural outcome of the primary instructional block resulting from the primary error and a target procedural outcome defined in the primary instructional block in Block S140; and associating the primary recovery block with the primary instructional block in Block S150.

### 1.2 Variation: Real-Time Recovery

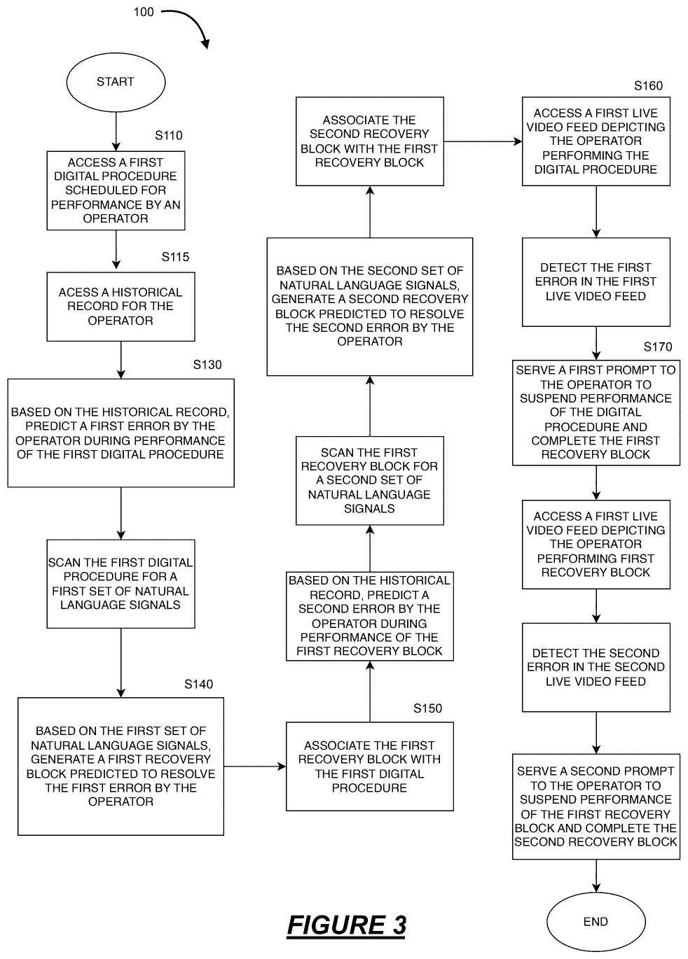

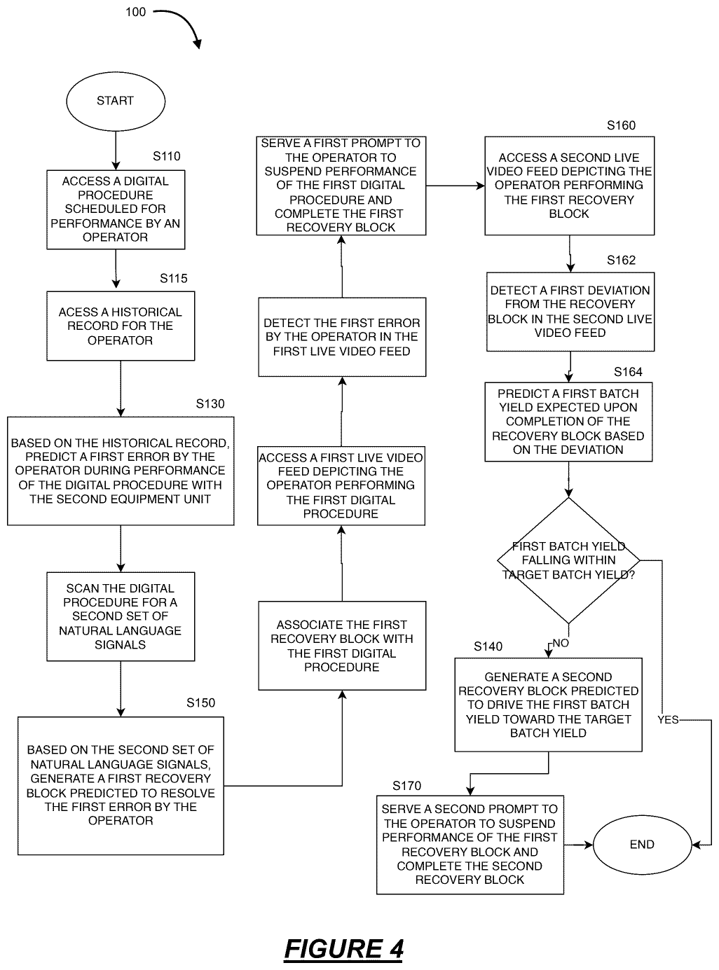

As shown in FIGS. 3 and 4, another variation of the method S100 includes accessing a digital procedure including a sequence of instructional blocks performable within a facility in Block S110.

This variation of the method S100 also includes, during performance of a primary instructional block, in the sequence of instructional blocks in the digital procedure, by an operator within the facility: accessing a primary live video feed, captured by an optical sensor, depicting performance of the primary instructional block by the operator in Block S160; detecting a primary deviation from the primary instructional block by the operator in the primary live video feed in Block S162; and, based on the primary deviation, predicting a primary anticipated procedural outcome expected upon completion of the primary instructional block by the operator in Block S164.

This variation of the method S100 further includes, in response to the primary anticipated procedural outcome exceeding a threshold deviation from a target procedural outcome: based on a primary set of natural language signals in the primary instructional block, generating a primary recovery block predicted to shift the primary anticipated procedural outcome toward the target procedural outcome defined in the primary instructional block in Block S140; and serving a prompt to the operator, in Block S170, to suspend performance of the primary instructional block and complete the primary recovery block.

### 2. Applications: Planned Recovery

Generally, Blocks of the method S100 can be executed by a computer system to, prior to performance of a new digital procedure by an operator at a facility (e.g., a pharmaceutical production facility): predict a procedural error—such as improper equipment unit operation, misinterpretation of an instruction, a timing deviation—by the operator based on a historical record of instances of digital procedures (i.e., excluding the new digital procedure) performed by the operator at the facility; and trigger a pre-trained generative transformer (e.g., a large language model) to generate (or modify) a recovery block (e.g., textual instructions, visual guidance) predicted to resolve (or reduce) adverse procedural conditions resulting from the procedural error. Additionally, Blocks of the method S100 can be executed by the computer system to, during scheduled performance of the new digital procedure by the operator: detect the procedural error by the operator, such as based on a live video feed captured by an optical sensor arranged proximal a workspace occupied by the operator; and serve a prompt to the operator to suspend performance of the new digital procedure and complete the recovery block for successful completion of the new digital procedure by the operator.

More specifically, rather than retrieving manually authored, general recovery instructions applicable to a corpus of operators at a facility, the computer system can: proactively generate recovery blocks for digital procedures tailored to resolve predicted errors by a particular operator for a new digital procedure; and retrieve these recovery blocks during real-time performance of the new digital procedure by the particular operator to promptly resolve errors and/or deviations that can result in reduced batch yield outputs, production delays, and wasted resources during production of pharmaceuticals designated for critical patient therapies.

In one implementation, the computer system can: access a historical record, such as including logged procedural errors and corresponding procedural outcomes, associated with a particular operator; and, based on contents (e.g., textual instructions, visual guidance) in an instructional block in the digital procedure and combinations of logged procedural errors and procedural outcomes represented in the historical record, predict a primary error by the operator during performance of the digital procedure. The computer system can then: generate a script (e.g., a natural language script) instructing a procedure authoring model (e.g., a large language model) to generate a recovery block that reduces a difference between an anticipated procedural outcome resulting from the primary error and a target procedural outcome defined in the instructional block in the digital procedure; serve the script to the procedural authoring model for execution; retrieve the recovery block from the procedural authoring model; and associate the recovery block with the instructional block.

In one example, the operator is scheduled to perform a new digital procedure with a new equipment unit within the facility. In this example, the computer system can: based on combinations of procedural errors and procedural outcomes represented in the historical record, predict a primary error by the operator with the new equipment unit; and generate a recovery block to resolve this predicted error by the operator during performance of the digital procedure.

Additionally, the computer system can: access the live video feed, captured by an optical sensor, depicting the operator performing the instructional block; and, based on visual features extracted from the live video feed, detect the primary error by the operator during performance of the instructional block. Accordingly, in response to detecting the primary error, the computer system can: retrieve the recovery block associated with the instructional block in the digital procedure; and serve a prompt to the operator to suspend performance of the instructional block and complete the recovery block to restore (or reduce) adverse procedural conditions resulting from the primary error for successful completion of the digital procedure by the operator.

Therefore, the computer system can preemptively generate a recovery block (or a set of recovery blocks) for a digital procedure to resolve predicted errors by an operator, thereby reducing likelihood of failures, production delays, and out-of-specification batch yields during performance of a digital procedure at the facility, such as during performance of a digital procedure to manufacture a custom pharmaceutical for a critical patient therapy.

### 2.1 Custom Digital Procedure

In one implementation, the computer system can: access a new digital procedure assigned to an operator at the facility; and generate an alternative digital procedure—which conforms to a procedure convention for performing digital procedures by the operator and predicted to yield a target procedural outcome of the new digital procedure—that replaces the new digital procedure. In this implementation, the computer system can, for each new instructional block in a sequence of instructional blocks in the new digital procedure: based on the historical record, predict a primary error by the operator during performance of the new instructional block; generate an alternative instructional block that is predicted to mitigate the primary error; and replace the new instructional block with the alternative instructional block to generate an alternative digital procedure.

Thus, the computer system can: prior to performance of a new digital procedure by the operator, modify the digital procedure by replacing instructional blocks—in the digital procedure—with tailored alternative instructional blocks that reflect operator-specific procedural strengths; and, during performance of the digital procedure, present these alternative instructional blocks to the operator, thereby reducing procedural errors by the operator.

### 2.2 Applications: Real-Time Recovery

Generally, Blocks of the method S100 can be executed by a computer system to: detect a real-time deviation during performance of the digital procedure by the operator; predict an adverse procedural outcome, such as a procedural risk event and a decrease in batch yield, that results from the real-time deviation by the operator; trigger the pre-trained generative transformer (e.g., the large language model) to autonomously generate a recovery block that is predicted to resolve the real-time deviation, mitigate the adverse procedural outcome, and restore procedural conditions for continued performance of the digital procedure; and present real-time recovery guidance—such as textual instructions, image overlays, video sequences, and augmented reality annotations—at an operator device associated with the operator to guide the operator in resolving the real-time deviation.

More specifically, rather than relying on a static recovery database limited to predefined error scenarios, the computer system can: generate recovery blocks in real time that are tailored to specific combinations of detected deviations, equipment configurations, material conditions, and operator contexts during real-time performance of digital procedures; and provide real-time recovery pathways—accounting for current procedural states and operational constraints during performance of the digital procedure—that enable the operator to successfully complete the digital procedure.

In one implementation, the computer system can: access a live video feed captured by an optical sensor that depicts an operator performing a digital procedure at a workspace within a facility; based on visual features extracted from the live video feed, detect a real-time deviation from the digital procedure by the operator; and predict an anticipated batch yield that results from this real-time deviation and expected upon completion of the digital procedure. The computer system can then, in response to the anticipated batch yield deviating from a target batch yield defined in the digital procedure, generate a recovery block predicted to reduce a difference between the anticipated batch yield and the target batch yield. Thus, during real-time performance of the digital procedure by the operator, the computer system can then: generate a prompt to suspend performance of the digital procedure; serve the prompt and the recovery block to an operator device (e.g., a tablet, augmented reality headset) associated with the operator; and present the recovery block at the operator device, such as by presenting textual instructions, rendering visual guidance, and broadcasting audio guidance at the operator device.

Therefore, rather than discarding an entire batch yield due to procedural deviations by the operator—which can impose significant financial costs and endanger patients dependent on timely production—the computer system can provide real-time recovery pathways to the operator that enable the operator to restore procedural conditions and obtain partial or complete recovery of a batch yield during performance of the digital procedure.

### 3. Terms and Definitions

Generally, “procedure authoring” as referred to herein is the modification and/or construction of instructional blocks of a digital procedure performed within a facility and/or corpus of facilities.

Generally, a “procedure convention” as referred to herein are combinations of instructions for digital procedures representative of (e.g., common to, typical of) digital procedures currently performed within a facility and/or corpus of facilities.

Generally, a “regulation convention” as referred to herein are combinations of regulations for digital procedures representative of (e.g., common to, typical of) digital procedures currently performed within a facility and/or corpus of facilities.

Generally, a “language signal” as referred to herein is a word or phrase that represents critical language concepts for performing steps of a digital procedure within a facility and/or corpus of facilities.

### 4. System

In one implementation, as shown in FIG. 1, the computer system can interface with: an operator device (e.g., a tablet, augmented reality headset, smartphone, wearable device) configured to present (e.g., render) a digital procedure to an operator; an optical sensor (e.g., a camera, RGB-D sensor)—such as arranged proximal the workspace or integrated into the operator device—configured to capture a live video feed depicting the operator performing the digital procedure; and a procedure authoring model (e.g., a pre-trained generative transformer) configured to autonomously generate instructional blocks in real time.

### 5. Digital Procedure

Block S110 of the method S100 recites accessing a digital procedure including a sequence of instructional blocks performable within a facility.

In one implementation, the computer system can: access a document (e.g., a paper-based document, an electronic document); identify a set of steps in the document; extract instructions (e.g., text-based instructions) for each step, in the set of steps, in the document; aggregate other supportive content for these steps, such as in the form of images, audio, video, or augmented reality content; compile this supportive content into individual instructional blocks containing instructions in different formats corresponding to different levels of human-targeted guidance; and order these individual blocks or define a pathway for these individual blocks (in a decision tree) to generate a new digital procedure. Upon receipt of this digital procedure, a mobile device can execute Blocks of the method S100 to serve instructions in each block in the digital procedure to a user interface to support performance of the digital procedure by the operator.

The computer system can then: repeat this process for multiple documents corresponding to multiple procedures at the facility; and store these sets of instructional blocks in an instructional block library.

### 5.1 Instructional Block Library

In one implementation, the computer system can: aggregate approved instructional blocks from each digital procedure performed at the facility; compile these instructional blocks from these digital procedures into an instructional block library; and store the instructional block library, such as at a remote computer system, for retrieval by devices within the facility.

In another implementation, the computer system can: at the mobile device of the operator, initialize a new instructional block; and generate a prompt for an operator to populate the new instructional block with an instruction. The computer system can then: serve this prompt at the mobile device of the operator; receive the instruction at the mobile device from the operator; and store this new populated instructional block at the instructional block library. For example, the computer system can: receive visual media for an instruction recorded by the operator via an optical sensor at the mobile device; receive a string of text from the operator representing the instruction via a computing interface at the mobile device; and/or receive audio media of the instruction recorded by the operator via a microphone at the mobile device. Additionally, the computer system can then populate the new instructional block with the text strings, audio media, and/or visual media received from the operator. Furthermore, the computer system can: confirm population of the new instructional block with the instruction from the operator; transmit this new instructional block to a supervisor device associated with a supervisor; and queue the new instructional block for approval and review by the supervisor. Accordingly, in response to confirmation of the new instructional block, the computer system can aggregate this new instructional block to the instructional block library.

### 7. Procedural Documentation

Generally, the computer system can: retrieve manuals (e.g., equipment unit manuals, regulation manuals) from a manual library at a remote computer system; retrieve transcript documents from a transcript document library representative of previous communications between consultants (e.g., quality consultants, health consultants) and operators within the facility; and implement these manuals and transcript documents to train generative models representative of procedure conventions carried out for digital procedures performed within the facility.

### 7.1 Equipment Unit Manuals

In one implementation, the computer system can: retrieve the equipment unit manual for a particular equipment unit in the facility from an external computer system (e.g., manual document database); implement computer vision techniques to scan the equipment unit manual to detect words, phrases, images in the equipment unit manual; identify an equipment unit identifier in the words, phrases, and images in the equipment unit manual that corresponds to a particular equipment unit in a corpus of equipment units deployed in the particular facility; and link the equipment unit manual to the particular equipment unit within the facility in an equipment unit manual library. Additionally or alternatively, the computer system can: scan a physical document (e.g., paper document) representing the equipment unit manual for the particular equipment unit; and store this digital document as the equipment unit manual in the manual database.

In particular, the equipment unit manual can represent: a detailed suite of instructions corresponding to instructions and/or methods of operation (e.g., calibration instructions, troubleshooting instructions, modifying parameter settings) for a particular equipment unit associated with a digital procedure; and/or a suite of regulations (e.g., safety instructions, government regulations) associated with preferred handling of the equipment unit during performance of digital procedures within the facility.

Thus, the computer system can: compile a suite of equipment unit manuals corresponding to a corpus of equipment units currently located within a particular facility; and generate an equipment unit library based on the suite of equipment unit manuals linked to the particular facility. The computer system can additionally compile a suite of specifications for consumables, raw materials, and other materials—located within the facility—from a corpus of available documentation, content, and digital guidance instructions.

### 7.2 Regulatory Procedure Manual

In one implementation, the computer system can: retrieve a regulatory procedure manual (e.g., safety regulation manual, environmental regulation manual) from an external computer system (e.g., regulatory document database) associated with a particular facility assigned to perform approved digital procedures; implement computer vision techniques to scan the regulatory procedure manual to detect words, phrases, and images in the regulatory procedure manual; detect a regulation identifier in the words, phrases, and images in the regulatory procedure manual corresponding to a particular approved digital procedure in a suite of approved digital procedures currently performed in the facility; and link words, phrases, and images, in the regulatory procedure manual to the approved digital procedure in a regulatory manual library. Additionally or alternatively, the computer system can: scan a physical document (e.g., paper document) representing the regulatory procedure manual for the particular facility; and store this digital document as the regulatory procedure manual in a regulatory manual database.

In particular, the regulatory procedure manual can represent: a detailed suite of instructions (e.g., handling instructions) corresponding to instructions and/or methods of execution for a particular equipment unit associated with an approved digital procedure; and/or a detailed suite of regulations (e.g., environmental regulations, safety regulations, quality assurance regulations) corresponding to regulations and/or methods of execution of a particular digital procedure within a corresponding region (e.g., state specific regulations, country specific regulations). Thus, the computer system can: compile a suite of regulatory procedure manuals corresponding to a suite of approved digital procedures currently performed and/or scheduled for performance at a particular facility; and generate a regulatory manual library based on the suite of regulatory procedure manuals linked to the particular facility.

### 7.3 Consultant Transcripts

In one implementation, the computer system can: retrieve a transcript document (e.g., audio, video, text transcript document) from an external computer system (e.g., transcript database) representative of communication between a consultant (e.g., safety consultant, quality consultant, environmental consultant, regulation specialist consultant) and an operator authoring digital procedures for the facility; implement computer vision techniques and/or audio recognition techniques to scan the transcript document to detect words, phrases, and images, in the transcript document; detect a regulation identifier in the words, phrases, and images in the transcript document corresponding to a particular approved digital procedure in a suite of approved digital procedures currently performed in the facility; and link words, phrases, and images in the transcript document to the approved digital procedure in a transcript database. Additionally or alternatively, the computer system can: scan a physical document (e.g., paper document) containing text communication between a consultant (e.g., safety consultant, environmental consultant) and the operator authoring the digital procedure; and store this digital document as the transcript document in a transcript document database.

In particular, the transcript document can represent: a suite of transcribed communications between a consultant (e.g., safety consultant, environmental consultant) supporting an administrator within the facility authoring a new digital procedure and/or transferring a digital procedure from a primary facility to a secondary facility; and a suite of media (e.g., diagrams, graphs, videos, images, audio) obtained from the consultant, which supports the operator in authoring verified instructional blocks for the particular facility. Thus, the computer system can: compile a suite of transcript documents representing previous communications between consultants (e.g., safety consultants, environmental consultants) and operators within the facility; and generate a transcript document library based on the suite of transcript documents associated with a particular facility and/or a corpus of facilities assigned to perform the particular digital procedure.

### 7.4 Historical Record

Block S115 of the method S100 recites accessing a historical record of instances of digital procedures performed by the operator at the facility. Generally, in Block S115, the computer system can access a historical record representing logged performance of the digital procedure, such as including procedural parameters, procedural errors, and procedural outcomes during performance of the digital procedure by the operator in the historical record.

In one implementation, the computer system can receive manual input of these procedural parameters, procedural errors, and procedural outcomes from the operator during performance of the digital procedure by the operator. In another implementation, during and/or following performance of the digital procedure by the operator, the computer system can: access the live video feed, captured by the optical sensor, depicting the operator performing the digital procedure; and, based on visual features extracted from the live video feed, detect procedural parameters, procedural errors, and procedural outcomes during performance of the digital procedure.

Therefore, the computer system can: maintain a historical record of instances of digital procedures performed by the operator at the facility; and leverage this historical record to predict future errors by the operator during performance of scheduled digital procedures at the facility, as described below.

### 8. Data Aggregation

In one implementation, the computer system can: initialize an equipment unit tag, in a set of equipment unit tags, representing a corpus of equipment units within the particular facility; populate the equipment unit tag with an equipment unit type (e.g., make and model), location within the particular facility, and calibration status of the equipment unit; and assign the equipment unit tag to the particular equipment unit at the particular facility. In this implementation, the computer system can then: query the instructional block library for a set of instructional blocks containing the equipment unit tag associated with the particular equipment unit; and aggregate the set of instructional blocks into a procedure data container corresponding to the particular equipment unit.

Furthermore, the computer system can scan the set of instructional blocks associated with the particular equipment unit and identify: sequences of texts representing steps of a procedure performed by an operator at the particular equipment unit; and images and/or video associated with the particular equipment unit. The computer system can then compile sets of data, in the procedure data container, corresponding to the sequences of texts, images, audio, and/or videos extracted from the set of instructional blocks and related to the application equipment unit.

In one example, the computer system can retrieve an equipment unit tag corresponding to a particular equipment unit within the facility analogous to a centrifuge machine located at a particular location in the facility. The computer system can then query the instructional block library for a set of instructional blocks related to and/or containing the equipment unit tag for the centrifuge machine. The instructional blocks, in the set of instructional blocks, can include: steps of a procedure related to and/or implementing the centrifuge machine within the facility; and a set of media, such as images and/or videos related to performing steps defined in the set of instructional blocks. In this example, the computer system can also: retrieve a centrifuge machine manual from the equipment unit manual library that corresponds to the centrifuge machine within the facility; and implement text recognition and/or computer vision techniques to the centrifuge machine manual to identify objects in the equipment unit manual. In particular, the computer system can: identify words and/or phrases associated with operation of the centrifuge machine; and identify reference images relevant to operation of the centrifuge machine within the facility in the equipment unit manual.

Therefore, the computer system can: aggregate data extracted from the set of instructional blocks—related to the particular equipment unit—in the procedure data container; aggregate data extracted from the equipment unit manual into the procedure data container; and subsequently train a procedure authoring model, as described below, to author (i.e., generate and/or modify) a new set of instructional blocks related to the particular equipment unit. Additionally or alternatively, the computer system can: access a procedure record library corresponding to previously performed digital procedures within the facility; scan the procedure record library to identify a set of procedure records associated with the particular equipment unit, as described above; and store the set of procedure records in the procedure data container.

### 8.1 Audio+Visual Data Aggregation

Additionally or alternatively, the computer system can: implement computer vision techniques, such as those described in U.S. patent application Ser. No. 17/968,677, filed on 18 Oct. 2022, which is hereby incorporated in its entirety by this reference, to detect objects in a sequence of images (e.g., images, video) in a set of procedure records associated with the particular equipment unit; and store the objects in the procedure data container associated with the particular equipment unit. Furthermore, the computer system can also: implement audio recognition techniques, such as those described in U.S. patent application Ser. No. 17/968,677, to detect audio phrases in the set of data related to the set of language signals in the set of procedure records; and store the audio phrases in the procedure data container associated with the particular equipment unit.

### 9. Generating Procedure Authoring Model

Generally, the computer system can: link sets of data in the procedure data container to a set of language signals representing language concepts corresponding to a procedure convention for a particular equipment unit within the facility; and train a model to generate a new sequence of instructional blocks associated with the particular equipment unit based on the set of language signals and existing digital procedures (e.g., approved digital procedures) currently performed in the facility.

### 9.1 Language Signals

The computer system can: implement language models—such as natural language processing models or natural language understanding models tuned to particular language concepts—to detect words or phrases that represent critical language concepts in the procedure data container associated with a particular equipment unit. Additionally or alternatively, the computer system can implement natural language processing techniques to detect syntax (grammar, punctuation, spelling, formatting, sequence) characteristics for words or phrases in the procedure data container for the particular equipment unit.

### 9.1.1 Action Signals

In one implementation, the computer system can: scan the set of instructional blocks and the equipment unit manual stored in the procedure data container; and implement an action signal model to detect words or phrases—in the set of instructional blocks and/or the equipment unit manual—related to actions and/or instructions associated with performance of digital procedures with the particular equipment unit. For example, the computer system can detect words or phrases in the set of instructional blocks and the equipment unit manual, such as: “mixing a primary material and a secondary material”; or “calibrate the centrifuge to a target parameter”.

Accordingly, the computer system can generate an action signal that represents the types and/or frequency of such action-related words or phrases in the procedure data container associated with the particular equipment unit. For example, for each word or phrase detected in the procedure data container, the computer system can: normalize the word or phrase; and generate a primary action signal containing the normalized language value. In this example, the computer system can: normalize “turn on the centrifuge”, “initiate the centrifuge”, “start the equipment unit” to “trigger centrifuge”; and store the normalized values in discrete action signals for the procedure data container.

In another example, the computer system generates a single action signal representing presence and/or absence of action requests detected in the procedure data container. The computer system can also derive and store a frequency of action requests detected in the set of instructional blocks and the equipment unit manual or represent a ratio of action requests to other words or phrases in the procedure data container.

### 9.1.2 Risk Signals

Similarly, the computer system can: scan the set of instructional blocks and the equipment unit manual in the procedure data container; and implement a risk signal model to detect words and/or phrases in the procedure data container related to threats, instability, and uncertainty associated with performance of digital procedures within the particular facility. For example, the computer system can detect words or phrases in the set of instructional blocks and the equipment unit manual, such as: “combustible materials”; “warning: do not inhale”; and/or “contents may be hot”.

Accordingly, the computer system can generate a risk signal that represents the types and/or frequency of such risk-related words or phrases in the procedure data container associated with the particular equipment unit. For example, for each word or phrase detected in the procedure data container, the computer system can: normalize the word or phrase; and generate a primary risk signal containing the normalized language value. In this example, the computer system can: normalize “flammable materials”, “incendiary hazard”, “combustible elements” to “fire risk”; and store the normalized values in discrete action signals for the procedure data container.

In another example, the computer system generates one risk signal representing presence and/or absence of risk-related words or phrases detected in the procedure data container. The computer system can also: derive and store a frequency of risk-related words or phrases detected in the set of instructional blocks and the equipment unit manual; or represent a ratio of risk-related words or phrases to other words or phrases in the procedure data container.

### 9.1.3 Equipment Unit Signals

In one implementation, the computer system can: scan the text content stored in the unverified draft instructional block; and implement an equipment unit language processing model to detect words or phrases—in the set of instructional blocks—related to a corpus of equipment units (e.g., centrifuges, bio-reactors) located within the facility. For example, the computer system can detect words or phrases in the set of instructional blocks, such as: “centrifuge model #ABCD”; “bio-reactor interface”; or “scale calibration”.

Accordingly, the computer system can generate an equipment unit signal that represent the equipment unit types of such equipment unit-related words or phrases in the unverified draft instructional block. For example, for each word or phrase detected in the unverified draft instructional block, the computer system can: normalize the word or phrase; and generate a primary equipment unit action signal containing the normalized language value. In this example, the computer system can normalize: “locate centrifuge model#AABB”, “bio-reactor parameters”, and “scale calibration”; and store the normalized values in discrete action signals for the unverified draft instructional block.

In another example, the computer system generates a single equipment unit signal representing presence and/or absence of equipment unit types specified in the unverified draft instructional block. The computer system can also derive and store a frequency of equipment unit signals detected in the set of instructional blocks or represent a ratio of equipment unit signals to other words or phrases in the unverified draft instructional block.

### 9.1.4 Regulation Signals

In one implementation, the computer system can: scan transcript documents in the transcript document library and regulation manuals in the regulation manual library aggregated into a data container; and implement a regulation signal model to detect words or phrases—in the transcript documents and/or the regulation manuals—related to regulations (e.g., health, safety regulations) and/or instructions associated with performance of digital procedures with a particular equipment unit within the facility. For example, the computer system can detect words or phrases in the transcript documents and the regulation manual, such as: “safety guidelines for hazardous materials”; “health guidelines for handling materials”; “environmental restrictions for equipment units”.

Accordingly, the computer system can generate a regulation signal that represents the types and/or frequency of such regulation-related words or phrases in the data container associated with a particular equipment unit and/or a particular facility. For example, for each word or phrase detected in the data container, the computer system can: normalize the word or phrase; and generate a primary regulation signal containing the normalized language value. In this example, the computer system can: normalize “hazardous material spill”, “incendiary condition”, and “hazardous gas exposure” to “environmental, health and safety regulation”; and store the normalized values in discrete regulation signals for the data container.

### 9.2 Model Generation+Procedure Convention

Generally, the computer system can: compile procedure signal containers—representing language concepts contained in the equipment unit manual and the set of instructional blocks—into a sender model that represents combinations of language concepts representative of a procedure convention for implementing the particular equipment unit during performance of steps of digital procedures within the facility. More specifically, the computer system can: scan the procedure data container—including the equipment unit manual and the set of instructional blocks—for a set of language signals (e.g., input signals, action signals, equipment unit signals, risk signals); detect combinations of language signals in the procedure data container; and train a procedure authoring model associated with the particular equipment unit to generate new sequences of instructional blocks based on: combinations of language signals in the equipment unit manual and the set of instructional blocks; and existing digital procedures currently performed within the facility. In particular, the procedure authoring model for the particular equipment unit is characterized by a procedure convention for implementing the new instructional blocks of the digital procedure within the facility by an operator performing the digital procedure with the particular equipment unit.

In one implementation, the computer system can: scan instructional blocks, an equipment unit manual, and procedure records contained in the procedure data container associated with the particular equipment unit; implement methods and techniques as described above to detect a set of language signals in the procedure data container; and define the procedure convention for the particular equipment unit based on a frequency of language signals, in the set of language signals, detected across the procedure data container. In one example, the computer system can: retrieve a primary digital procedure including a primary set of instructional blocks associated with the particular equipment unit in the facility; scan the primary set of instructional blocks to detect a set of language signals; and calculate correlations between the set of language signals extracted from the primary set of instructional blocks and the frequency of language signals defined in the procedure convention for the particular equipment unit.

Thus, the computer system can, in response to a correlation exceeding a threshold correlation, interpret the primary digital procedure as non-conforming to the procedure convention defined for the particular equipment unit (i.e., the primary digital procedure deviates from common or typical procedures performed using the particular equipment unit within the facility).

### 9.2.1 Model Generation: Neural Network

In one implementation, the computer system implements artificial intelligence, machine learning, regression, and/or other techniques to train a neural network to generate a sequence of instructional blocks associated with a particular equipment unit within the facility to accomplish a target outcome (e.g., calibration, batch yield).

In this implementation, the computer system can access a procedure data container for a particular equipment unit, such as containing: a primary set of data corresponding to words or phrases extracted from an equipment unit manual specifying instruction and/or regulations for operation of the particular equipment unit; a secondary set of data corresponding to words or phrases extracted from a set of instructional blocks, retrieved from the instructional block library, associated with the particular equipment unit; and a third set of data corresponding to words or phrases extracted from a set of procedure records, retrieved from the record library, representing previously performed instances of digital procedures that implemented the particular equipment unit. The computer system can then implement methods and techniques described above to: detect a set of language signals from these sets of data; initialize a primary procedure container associated with the particular equipment unit; and store the set of language signals in the primary procedure container.

The computer system can thus: repeat this process for a corpus of equipment units located within the facility; and train the procedure authoring model to identify similarities and differences between integration of equipment units across the corpus of equipment units within the facility. The computer system can also: repeat this process for a corpus of equipment units across a corpus of facilities; and train the procedure authoring model to identify similarities and differences between integration of equipment units across the corpus of facilities.

Additionally, or alternatively, the computer system can: access a set of unapproved (or “failed”) procedure records from the procedure record library associated with the particular equipment unit and representing unapproved instances of digital procedures involving the particular equipment unit performed within the facility; detect a set of language signals in this set of unapproved procedure records; initialize a secondary digital procedure container associated with the particular equipment unit; and store the set of language signals in the secondary digital procedure container.

### 9.2.2 Model Generation: Deep Learning

In another implementation, the computer system implements deep learning techniques (e.g., transformer networks) to train a neural network to generate new sequences of instructional blocks corresponding to a particular equipment unit available for implementation within the facility.

### 9.3 Procedure Verification Model

Similarly, the computer system can implement steps and techniques described above to: link sets of data—extracted from transcript documents (e.g., consultant transcripts) and regulation manuals (e.g., health regulation manual)—in the data container to a set of language signals representing language concepts corresponding to a regulation convention for a particular equipment unit within the facility; and train a model to interpret compliance of a sequence of steps to the regulation convention for the particular equipment unit within the facility based on the set of language signals and existing digital procedures (e.g., verified digital procedures) currently performed within the facility.

In one implementation, the computer system can: access an unverified draft instructional block containing a sequence of steps, such as authored by an operator and/or generated by a procedure authoring model; scan the unverified draft instructional block for a set of language signals; correlate an equipment unit language signal, in the set of language signals, with a particular equipment unit proximal a workspace within the facility; and, in response to correlating the equipment unit language signal with the particular equipment unit, retrieve a procedure verification model representative of a procedure convention for the particular equipment unit.

The computer system can then: correlate a regulation language signal, in the set of language signals, with a regulation prompt (e.g., health, safety, environmental regulation) related to the particular equipment unit; and, based on the regulation language signal and the procedure verification model, interpret a procedure verification score for the sequence of steps specified in the unverified draft instructional block representative of a degree of compliance of the sequence of steps with regulation conventions (e.g., health, safety, environmental regulations) adhered to at the facility.

Accordingly, in response to the procedure verification score exceeding a threshold verification score, the computer system can: transform the unverified draft instructional block containing the sequence of steps to a verified instructional block; and store the verified instructional block in the instructional block library. Alternatively, in response to the procedure verification score falling below a threshold verification score, the computer system can flag the unverified draft instructional block for manual review by a supervisor overseeing performance of digital procedures within the facility.

Therefore, the computer system can: retrieve an unverified draft instructional block containing a sequence of steps for execution at a particular equipment unit at a facility; and implement the procedure verification model to automatically transform the unverified draft instructional block to a verified instructional block to enable operators to perform the sequence of steps within the facility.

### 9.4 Agentic Platform

In one implementation, the computer system can repeat the steps and processes described above to generate and train multiple instances of generative transformer models that cooperate to support ad-hoc and planned procedure authoring within the facility. For example, the computer system can generate and train a set of generative transformer models including: a regulatory compliance model configured to generate (or modify) instructional blocks compatible with regulations (e.g., local, federal regulations) governing the facility; a quality assurance model configured to generate (or modify) instructional blocks predicted to yield procedural outcomes of digital procedures within a target batch yield and/or target batch quality; and a manufacturing engineer model configured to generate (or modify) instructional blocks compatible with available materials and/or equipment units within the facility.

Accordingly, the computer system can then: aggregate the set of generative transformer models into an agentic platform; and sequentially order the set of generative transformer models, in the agentic platform, according to an assigned weight to each generative transformer model. Thus, rather than generating instructional blocks based on a single generative transformer model, the computer system can leverage an agentic platform including a set of generative pre-trained transformer models that cooperate to: receive natural language prompts from operators and/or administrators within the facility; and transform these natural language prompts into natural language responses that support planning, review, and/or real-time performance of digital procedures performed at the facility.

In one example, the computer system can: via a procedural authoring model, generate (or modify) a first instance of a new instructional block predicted to yield a target procedural outcome at the facility; transmit this new instructional block to a regulatory compliance model to generate (or modify) a second instance of the new instructional block predicted to yield the target procedural outcome within regulatory constraints governing the facility; and transmit the second instance of the new digital procedure to a manufacturing engineering model to generate (or modify) a third instance of the new instructional block predicted to yield the target procedural outcome with a new equipment unit at the facility and within the regulatory constraints governing the facility.

Additionally, the computer system can: record prompts transmitted to the agentic platform and responses from the agentic platform in an audit trail; and store this audit trail for manual review by administrators at the facility and/or for training new or existing generative transformer models for the facility.

### 10. Procedure Authoring

Generally, the computer system can: receive a prompt to generate a sequence of instructional blocks (e.g., for calibrating the equipment unit, output a target batch yield, measuring an article) such as, at an operator device associated with an operator proximal the particular equipment unit within the facility; scan the prompt to detect the set of language signals associated with the particular equipment unit; and generate a current sequence of instructional blocks based on the set of language signals detected in the prompt and the procedure authoring model associated with the particular equipment unit.

In particular the computer system can: initialize a prompt at an operator device associated with an operator located proximal the particular equipment unit within the facility; populate the prompt with words or phrases input by the operator at the operator device; scan the words or phrases in the prompt to detect the set of language signals; and input the set of language signals detected in the procedure authoring model to generate a current sequence of the instructional blocks. The computer system can then: compile the sequence of instructional blocks into a visual media, such as a flowchart diagram, and/or blocks of text; and output the visual media at a display integrated into the operator device associated with the operator.

In one implementation, the computer system can: receive modifications and/or edits to the prompt, such as input by the operator at the operator device; and input the modified prompt into the procedure authoring model to generate a secondary sequence of instructional blocks associated with the particular equipment unit.

In another implementation, the computer system can: input the prompt into the procedure authoring model to generate a modifiable sequence of instructional blocks associated with the particular equipment unit; and output the modifiable sequence of instructional blocks at the operator device. In this implementation, the operator device can: receive manual authoring of the generated sequence of instructional blocks from the operator; and transmit the modified sequence of instructional blocks, such as to the instructional block library and/or to a remote viewer for inspection and/or review.

### 10.1 Ad-Hoc Procedure Authoring

In one implementation, the computer system can: access a set of wireless signals received from an operator device associated with an operator within the facility; localize the operator device at a primary location within the facility based on the set of wireless signals and a facility map; detect a particular equipment unit proximal the primary location within the facility, such as based on visual features extracted from optical sensors proximal the primary location and/or manual confirmation of presence of the particular equipment unit by the operator at the operator device. The computer system can then retrieve a particular procedure authoring model, from a set of procedure authoring models, associated with the particular equipment unit detected proximal the primary location in the facility. Thus, the computer system can, in response to detecting the particular equipment unit proximal the primary location: initialize a prompt for the operator to input a string of text representing the procedure authoring request; and serve the prompt to the operator device.

The operator device can then: populate the prompt with a string of text received from the operator handling the operator device, such as “Does this equipment unit need to be calibrated?”, “Please provide instructions to use this equipment unit”, or “what are the inputs for this equipment unit”; generate the procedure authoring request based on the string of text received at the operator device; and transmit the procedure authoring request to the computer system for input into the procedure authoring model associated with the particular equipment unit. The computer system can then: scan the procedure authoring request to detect a primary action signal (e.g., calibrate, measure, mix), in the set of language signals; and input the primary action signal into the procedure authoring model to generate a sequence of instructional blocks predicted to yield a desired outcome for the action-related request identified in the procedure authoring request.

In one example, the operator can transmit a procedure authoring request corresponding to “provide instructions for calibrating this centrifuge machine” to the computer system. The computer system can thus: detect “calibrate” as an action signal in the procedure authoring request; input the “calibrate” action signal into a procedure authoring model for the centrifuge machine; and generate a sequence of instructional blocks for calibrating the centrifuge machine according to a procedure convention defined in the procedure authoring model. In this example, the computer system can then: transmit the generated sequence of instructional blocks to the operator device; and transmit images, video, and/or sections of the equipment unit manual associated with the “calibrate” action signal to the operator device. As described above, the operator device can: transmit secondary procedure authoring requests to the computer system following generation of the sequence of instructional blocks; and/or modify a previous procedure authoring request sent to the computer system to generate a new sequence of instructional blocks until a desired outcome is achieved by the operator.

Therefore, the computer system can: in real-time receive a procedure authoring request from an operator device proximal a particular equipment unit within the facility; and autonomously generate a sequence of instructional blocks to achieve an outcome of the procedure authoring request when performed by the operator within the facility.

### 10.2 Planned Procedure Authoring

In one implementation, the computer system can: access a facility schedule specifying time periods (e.g., a week, a month) for performing steps of digital procedures related to a set of equipment units within the facility; and identify a particular equipment unit scheduled for maintenance in the facility schedule. The computer system can then: identify a secondary equipment unit, in a corpus of equipment units, within the facility similar to the particular equipment unit scheduled for maintenance; retrieve a procedure authoring model associated with this secondary equipment unit; and generate a sequence of instructional blocks, as described above, based on the procedure authoring model to replace the particular unit scheduled for maintenance within the facility with the secondary equipment unit. Thus, the computer system can stage digital procedures scheduled for performance within the facility to cycle (or “replace”) existing equipment units utilized for performing digital procedures within the facility.

### 10.3 Procedure Authoring Across Corpus of Facilities

In one implementation, the computer system can: identify an equipment unit type located across a corpus of facilities; and implement methods and techniques as described above to generate a procedure authoring model associated with the equipment unit type and characteristic of a procedure convention for implementing the equipment unit type across the corpus of facilities. Thus, the computer system can: receive a procedure authoring request associated with a particular unit type across a corpus of facilities; and generate a sequence of instructional blocks for the particular equipment unit type for implementation of the digital procedure across the corpus of facilities.

### 10.4 Procedure Authoring Model Re-Training

In one implementation, the computer system can: generate a prompt requesting a user to score an outcome of the sequence of instructional blocks following performance by the operator within the facility; and transmit this prompt to the operator device associated with the operator. In response to the operator selecting a score above a threshold score, the computer system can then append the sequence of instructional blocks to the set of instructional blocks within the procedure data container for training the procedure authoring model associated with the particular equipment unit. The computer system can thus repeat this process across sets of instructional blocks generated by the procedure authoring model to routinely train the procedure authoring model associated with the particular equipment unit.

### 11. Generating Guidance

Generally, the computer system can: as described above, correlate data in the procedure data container associated with the particular equipment unit with a set of risk language signals; link media (e.g., images, strings of text, video) in the procedure data container linked to the set of language signals; and autonomously generate media (e.g., audio, video, images, augmented reality) based on the set of risk language signals aggregated from the procedure data container to mitigate exposure of risk to an operator performing procedures at the particular equipment unit. In particular, the computer system can: receive a guidance media request from an operator, such as by accessing a string of text from an operator device input by an operator performing steps of a procedure at the particular equipment unit; generate “ad-hoc” media to mitigate exposure to risk to the operator based on risk language signals detected in the guidance media request and the set of data in the procedure data container linked to these risk language signals; and transmit the media to the operator, such as by displaying text, images, video at the operator device (e.g., headset, tablet, autonomous cart) and/or broadcasting audio at the operator device.

Additionally and/or alternatively, the computer system can: correlate sets of data extracted from a procedure data container associated with a particular equipment unit to a set of risk language signals; and, in response to a risk correlation exceeding a threshold correlation, generate guidance media (e.g., text, images, video, augmented reality, audio) based on the set of risk language signals in the procedure data container.

Thus, the computer system can then: generate a new digital procedure for the particular equipment unit based on the procedure authoring request accessed from the operator device; retrieve the guidance media corresponding to the set of risk language signals associated with the particular equipment unit; and transmit the new digital procedure and the guidance media to the operator device to support the operator during performance of the new digital procedure at the particular equipment unit.

### 11.1 Ad-Hoc Generated Guidance

In one implementation, the computer system can: receive a guidance request from an operator to autonomously generate new media to support the operator in mitigating exposure to risk associated with performing steps of a procedure associated with the particular equipment unit; scan the guidance request for a primary set of language signals; and identify a risk signal, in the primary set of language signals, for the guidance request. The computer system can then: autonomously generate guidance media (e.g., audio, video, images) to mitigate exposure to a risk event (e.g., explosion, hazardous material exposure) associated with the risk signal in the guidance request; and transmit the guidance media to the operator, such as by displaying an image at a headset device, broadcasting audio at an autonomous cart proximal the particular equipment unit within the facility, and/or displaying text at a tablet device associated with the operator.

In one example, the computer system can: as described above, receive a guidance request from an operator device associated with the operator proximal the particular equipment unit, such as “How to resolve warning #100a923 indicated at bioreactor?”; scan the guidance request for a set of language signals; and interpret a risk signal in the set of language signals (e.g., warning #100a923) in the guidance request corresponding to a hazardous material warning at the bioreactor. Thus, the computer system can then: generate a prompt for a user to select a guidance media type (e.g., audio, video, images) for the risk signal indicated in the guidance request; and transmit this prompt to the operator device associated with the operator. The operator device can then: receive selection of the guidance media type, such as from the operator interacting with the operator device; and transmit this selection to the computer system.

In this example, the computer system can then: scan the equipment unit manual for the particular equipment unit for the risk signal; scan the set of instructional blocks associated with the particular equipment unit for the risk signal; extract strings of text, images, charts, from the equipment unit manual and the set of instructional blocks associated with the hazardous material risk signal for the bioreactor; and aggregate the strings of text, images, and charts into a digital document (e.g., a pdf document); and transmit this document to the operator device associated with the operator.

Additionally and/or alternatively, the computer system can: implement a voiceover model (or “text-to-speech”) to convert strings of text in the digital document into an audio file; transmit this audio file to an operator device (e.g., tablet, smart glasses, autonomous cart) proximal the particular equipment unit; and broadcast this audio file, such as via a speaker coupled to the operator device toward the operator performing steps of the digital procedure proximal the particular equipment unit. Furthermore, the computer system can: query the record library for a particular record associated with the risk event of the guidance request; extract a video feed from the particular record depicting appropriate actions to mitigate exposure to the risk event for the particular equipment unit; and transmit the video feed to the operator device associated with the operator.

In an additional example, the ad-hoc generated guidance can be initiated by the computer system based on an event. The event that occurs can be manually entered into, automatically reported via an integrated system, or automatically detected by the computer system, assigned a risk score based on the severity of the event, where the risk score exceeds a set threshold to the operator, end-user (patient), or product.

Therefore, the computer system can: receive (e.g., in real time) a guidance request from an operator device associated with a particular equipment unit within the facility; generate (e.g., ad-hoc) guidance media (e.g., video, images, audio) for the operator to mitigate exposure to a risk event associated with the guidance request received from the operator; and transmit this guidance media to an operator device associated with the operator.

### 11.2 Planned Guidance

In one implementation, during the initial time period, the computer system can: correlate sets of data in the procedure data container—associated with a particular equipment unit within the facility—to a set of risk signals, as described above; interpret a set of risk events based on subsets of risk signals, in the set of risk signals, associated with the particular equipment unit; and autonomously generate guidance media to support an operator interfacing with the particular equipment unit in mitigating exposure to these risk events.

In this implementation, the computer system can then: receive a procedure authoring request from the operator device associated with the operator; detect an action signal in the procedure authoring request; and detect a risk signal in the procedure authoring request associated with a particular risk event. Thus, during a deployment period, the computer system can then: generate a new procedure, as described above, based on the action signal and the procedure authoring model; retrieve the guidance media associated with the risk event previously generated by the computer system; and transmit the guidance media to the operator device associated with the operator. The operator device can thus load the new procedure and the guidance media for display at the operator device.

For example, the computer system can: interpret an incendiary risk event based on a primary subset of risk signals containing “combustible”, “caution: heat”, and/or “flammable material”; interpret a contamination risk event based on a secondary subset of risk signals containing “hazardous”, “do not mix”, and/or “isolation”; and interpret a calibration risk event based on a third secondary subset of risk signals containing “update calibration”, “out of specification”, and/or “calibration warning”. The computer system can then, during the initial time period: generate an audible alert warning the operator of the incendiary risk event based on the primary subset of risk signals; generate a warning image depicting the contamination risk event based on the secondary subset of risk signals; and generate a set of instructional blocks for calibrating the equipment unit based on the third subset of risk signals and the procedure authoring model. The computer system can then: aggregate the audible alert, the warning image, and the set of instructional blocks for calibrating the equipment unit into a guidance media container associated with the particular equipment unit; and, in response to detecting the set of risk signals in the procedure authoring request, transmit the guidance media container to the operator device associated with the operator.

Therefore, during the deployment period, the computer system can: detect a risk signal in a procedure authoring request for a particular equipment unit received from an operator device; and retrieve guidance media—previously generated by the computer system—associated with the risk signal and the particular equipment unit; and concurrently load a new digital procedure and the guidance media at an operator device associated with the operator interfacing with the particular equipment unit.

### 12. Planned Recovery

Blocks of the method S100 recite, prior to performance of the digital procedure by the operator: based on the historical record, predicting a primary error by the operator during performance of a primary instructional block in the sequence of instructional blocks in the digital procedure in Block S130; based on a primary set of natural language signals in the primary instructional block, generating a primary recovery block predicted to reduce a difference between a primary anticipated procedural outcome of the primary instructional block resulting from the primary error and a target procedural outcome defined in the primary instructional block in Block S140; and associating the primary recovery block with the primary instructional block in Block S150.

Generally, in Blocks S130, S140, and S150, the computer system can: extract previous procedural errors and previous procedural outcomes corresponding to these procedural errors from the historical record; based on these previous procedural errors and previous procedural outcomes, predict a procedural error (e.g., an incorrect manufacturing input, an invalid parameter selection at an equipment unit) by an operator; and generate a recovery block predicted to resolve this procedural error during future completion of the digital procedure by the operator.

### 12.1 Predicting Errors

In one implementation, the computer system can correlate a subset of previous instances of instructional blocks—in previous instances of digital procedures performed by the operator at the facility—represented in the historical record with the primary instructional block of the digital procedure The computer system can then extract from the historical record: a primary set of errors occurring during the subset of previous instances of instructional blocks performed by the operator at the facility; and a primary set of procedural outcomes resulting from the primary set of errors. Accordingly, the computer system can predict the primary error by the operator during performance of the primary instructional block based on the primary set of errors and the primary set of procedural outcomes. For example, the computer system can predict: non-compliant operator actions performed by the operator during performance of the primary instructional block; non-compliant selection of a parameter at an equipment unit during performance of the primary instructional block; and a time period exceeding a threshold time period specified for performance of the primary instructional block.

In another implementation, the computer system can: access an operator profile defining procedural conventions for the operator, such as historically preferred reagent handling techniques or timing sequences; extract operator-specific procedural errors (e.g., incorrect reagent selection, insufficient sterilization) and corresponding batch outcomes (e.g., contamination events, reduced viability) from the historical record; and simulate performance of the instructional block by combining extracted errors, batch outcomes, and procedural conventions defined in the operator profile to predict errors likely to recur during performance of the instructional block by the operator.

Therefore, the computer system can autonomously identify instructional blocks prone to recurrent operator-specific deviations and proactively modify these blocks to tailor digital procedures to individual operator strengths and minimize likelihood of procedural errors.

### 12.2 Planned Recovery Block

Generally, the computer system can: access (or generate) a textual description of the procedural error; and generate a script instructing a procedural authoring model to, based on a primary set of natural language signals in the primary instructional block and a secondary set of natural language signals in the textual description, generate the recovery block.

In one implementation, the script includes instructions for the procedure authoring model to: simulate performance of the primary instructional block by the operator to predict a primary anticipated procedural outcome resulting from the primary error; extract the target procedural outcome from the primary instructional block; and generate textual instructions, performable by the operator, predicted to reduce the difference between the primary anticipated procedural outcome resulting from the primary error and the target procedural outcome. For example, the computer system can—via the procedure authoring model—predict: an anticipated batch yield of the primary instructional block resulting from the primary error and expected upon completion of the primary instructional block by the operator; and, in response to the anticipated batch yield falling outside of a target batch yield, generate the primary recovery block predicted to drive the anticipated batch yield toward the target batch yield specified in the primary instructional block.

In another implementation, the script includes instructions for the procedure authoring model to: generate textual instructions, performable by the operator, for reducing the difference between the primary anticipated procedural outcome resulting from the primary error and the target procedural outcome defined in the primary instructional block; and generate a visual representation (e.g., an image, a video, an augmented reality representation) of the textual instructions. Accordingly, the computer system can then: serve the primary script to the procedure authoring model for execution; and receive the textual instructions and the visual representation from the procedural authoring model.

Therefore, the computer system can preemptively generate a recovery block including textual guidance and/or visual guidance to: resolve a primary error likely to occur during performance of the digital procedure by the operator; and enable the operator to restore procedural conditions for successful completion of the digital procedure.

### 12.2.1 Querying Block Library

In one implementation, the script includes instructions for the procedure authoring model to: query the instructional block library for a verified recovery block associated with the primary error; and, in response to absence of the verified recovery block in the instructional block library, generate the primary recovery block. Accordingly, following generation of this primary recovery block, the computer system can then aggregate the primary recovery block to the instructional block library, such as following manual review of the primary recovery block at a review portal.

Thus, the computer system can search the instructional block library for analogous (or similar) verified recovery blocks associated with the primary error to conserve computational resources for generating new recovery blocks during performance of digital procedures.

### 12.2.2 Recovery Block Compliance

In one implementation, the computer system can iteratively generate (or modify) variations of the primary recovery block to ensure procedural compliance of the primary recovery block at the facility. In particular, the computer system can iteratively serve draft recovery blocks across a corpus of generative pre-trained transformer models in the agentic platform to generate a primary recovery block compliant with the procedure conventions of the facility and predicted to yield the target procedural outcome.

In this implementation, the computer system can—based on the primary set of natural language signals in the primary instructional block and the procedure authoring model—generate an initial recovery block predicted to reduce the difference between the primary anticipated procedural outcome resulting from the primary error and the target procedural outcome. The computer system can then: calculate a primary compliance for completion of the initial recovery block at the facility; and, in response to the primary compliance falling below a target compliance, generate the primary recovery block—based on a secondary set of natural language signals in the initial recovery block and a procedure compliance model—predicted to: reduce the difference between the primary anticipated procedural outcome resulting from the primary error and the target procedural outcome; and shift the primary compliance toward the target compliance.

The computer system can then repeat this process across a hierarchy of generative pre-trained transformer models in the agentic platform until the primary recovery block adheres to the procedure convention of the facility and is predicted to yield the target procedural outcome. Therefore, the computer system can: autonomously verify recovery blocks generated in preparation for digital procedures performed at the facility; and maintain regulatory and/or procedural compliance of these recovery blocks for implementation at the facility.

### 12.2.3 Non-Operational Equipment Unit

Blocks S120, S122 and S124 of the method S100 recite, in response to non-operability of a primary equipment unit related to performance of an initial instructional block in the set of instructional blocks in the digital procedure: identifying a secondary equipment unit available for operation within the facility and compatible with the initial instructional block; based on an initial set of natural language signals in the initial instructional block, generating a primary instructional block predicted to yield an initial procedural outcome of the initial primary instructional block with the secondary equipment unit; and replacing the initial instructional block with the primary instructional block in the digital procedure.

In one implementation, the computer system can generate (or modify) an initial instructional block in the digital procedure responsive to a non-operational status of a primary equipment unit within the facility associated with performance of the initial instructional block. In this implementation, the computer system can: assign a secondary equipment unit available for operation within the facility and compatible with the initial instructional block to the operator for completion of the digital procedure; and, in response to inexperience of the operator with the secondary equipment unit—which can result in increase of likelihood of errors by the operator—generate a new instructional block that replaces the initial instructional block and guides the operator to interface with the secondary equipment unit to reduce likelihood of errors by the operator with the secondary equipment unit.

More specifically, in response to absence of instances of the operator performing digital procedures with the secondary equipment unit in the historical record, the computer system can: access a manual associated with the secondary equipment unit; based on a set of natural language signals in the initial instructional block and the manual, generate the primary instructional block predicted to yield an initial procedural outcome of the initial instructional block with the secondary equipment unit and reduce likelihood of errors by the operator with the secondary equipment unit; and replace the initial instructional block with the primary instructional block in the digital procedure.

Additionally, as described above, the computer system can then generate a primary recovery block for the new instructional block—that replaces the initial recovery block—in order to address and resolve predicted errors by the operator with the secondary equipment unit. Thus, the computer system can reduce likelihood of failure for performance scheduled digital procedure—such as a time-sensitive digital procedure for manufacturing a pharmaceutical designated for a critical patient therapy—by generating new instructional blocks of for this scheduled digital procedure and defining recovery pathways for predicted errors of these new instructional blocks for successful completion of the scheduled digital procedure at the facility by the operator.

In one example, the computer system can: extract, from the initial instructional block, a primary parameter specified for selection by the operator at the primary equipment unit during performance of the initial instructional block; extract, from the primary instructional block, a secondary parameter, different from the primary parameter, specified for selection by the operator at the secondary equipment unit during performance of the primary instructional block; and predict an invalid selection of the primary parameter by the operator at the secondary equipment unit during performance of the primary instructional block. The computer system can then generate the primary recovery block predicted to reduce a difference between the primary anticipated procedural outcome resulting from the invalid selection of the primary parameter by the operator at the secondary equipment unit and the target procedural outcome defined in the primary instructional block.

Therefore, the computer system can preemptively: generate (or modify) instructional blocks in the digital procedure to reduce likelihood of errors by the operator; and generate recovery blocks to resolve predicted errors for these generated (or modified) instructional blocks in the digital procedure.

### 12.3 Recovery Block Association

Generally, in response to manual and/or autonomous confirmation of a generated recovery block predicted to resolve errors by the operator, the computer system can link the generated recovery block to a corresponding instructional block in the digital procedure in preparation for future performance of the digital procedure by the operator.

In one implementation, the computer system can: calculate a secondary compliance for completion of the primary recovery block at the facility, such as by serving the primary recovery block to a procedure compliance model for execution; and, in response to the secondary compliance falling within the target compliance, autonomously associate the primary recovery block with the primary instructional block. In another implementation, the computer system can: generate a secondary prompt to manually review the primary recovery block; serve the secondary prompt, the historical record, and the primary recovery block to a review portal; and, in response to confirmation of the primary recovery block at the review portal, associate the primary recovery block with the primary instructional block.

Therefore, the computer system can associate generated recovery blocks with instructional blocks—in the scheduled digital procedure—which exhibit a high likelihood of predicted errors by the operator to define a recovery pathway (or a recovery tree) to support successful completion of the scheduled digital procedure by the operator.

### 12.4 Recovery Block Compatibility

In one implementation, completion of a generated (or modified) recovery block in the digital procedure can result in a procedural incapability between one or more succeeding instructional blocks in the digital procedure. Accordingly, the computer system can generate an additional recovery block (or sequence of additional instructional blocks) to preemptively resolve this procedural incompatibility and maintain procedural continuity along different procedural pathways for successful completion of the digital procedure by the operator.

In this implementation, the computer system can calculate a procedural compatibility between an anticipated recovery outcome of the primary recovery block and a succeeding instructional block in the digital procedure, such as by serving the primary recovery block to a procedure compliance model. Accordingly, in response to the procedural compatibility falling below a compatibility threshold, the computer system can: generate an alternative instructional block compatible with the anticipated recovery outcome and predicted to yield a secondary anticipated procedural outcome of the succeeding instructional block; and associate the alternative instructional block with the succeeding instructional block. Thus, following completion of the primary recovery block by the operator, the computer system can serve a secondary prompt to the operator to complete the alternative instructional block.

Therefore, the computer system can preemptively generate a set of recovery blocks that link to instructional blocks in the digital procedure to define one or more recovery paths for successful completion of the digital procedure by the operator.

### 12.5 Tailored Digital Procedure

Generally, the computer system can: access an operator-specific profile defining procedural conventions historically effective for the operator; detect a primary error rate, from the historical record, indicative of frequent operator errors in executing the particular digital procedure; and, in response to the detected error rate exceeding a threshold error rate, initiate tailoring of the digital procedure to align with the procedural conventions, thereby reducing operator-specific errors during performance of the digital procedure.

In one implementation, the computer system can: generate a script specifying instructions to modify parameters or actions within the original sequence of instructional blocks—such as adjusting reagent volumes, modifying incubation durations, or specifying alternative equipment units—to align procedural steps with historically successful procedural conventions associated with the operator; transmit the script as a structured request, defining target procedural outcomes (e.g., reduced contamination risk, increased batch yield), to the procedure authoring model; and receive, from the procedure authoring model, a tailored sequence of instructional blocks containing textual instructions and visual guidance, configured to reduce operator-specific errors identified in the historical record during performance of the digital procedure.

As described above, in response to confirmation of the tailored sequence of instructional blocks, the computer system can: replace the original sequence of instructional blocks in the digital procedure with the tailored sequence of instructional blocks specifically aligned to historical procedural conventions effective for the operator; and stage the modified digital procedure to reduce the likelihood of recurring operator errors and maintaining target procedural outcomes for future executions of the digital procedure by the operator at the facility.

### 13. Contextual Awareness: Performing the Digital Procedure

Block S160 of the method S100 recites, during performance of the primary instructional block by the operator, accessing a primary live video feed, captured by an optical sensor, depicting performance of the primary instructional block by the operator.

The computer system can implement computer vision techniques, such as those described in U.S. patent application Ser. No. 17/968,677, filed on 18 Oct. 2022, which is hereby incorporated in its entirety by this reference to: access a live video feed depicting an operator performing an instance of a digital procedure within the facility; extract a set of visual features from the live video feed; and detect objects (e.g., equipment units) and/or interpret operator actions during performance of the digital procedure based on the set of visual features extracted from the live video feed. Accordingly, the computer system can then: detect deviations and errors between objects (e.g., equipment units) handled by the operator during a current instance of the digital procedure and previous instances of the digital procedure performed at the facility; and/or detect deviations and errors between operator actions (e.g., operator movement, duration of time) executed by the operator during the current instance of the digital procedure and previous instances of the digital procedure performed at the facility.

In one implementation, the computer system can: access a particular digital procedure scheduled for performance at the facility by an operator; receive a prompt from an operator to initialize a primary instructional block in the particular digital procedure; and extract an object manifest from the primary instructional block corresponding to approved objects (e.g., equipment units) within the facility for performing the primary instructional block. The computer system can then: access a live video feed, such as from an optical sensor mounted at a headset device associated with the operator and/or mounted to an autonomous cart proximal the operator depicting the operator performing steps of the primary instructional block; extract a set of visual features, such as from a particular frame in the live video feed depicting the operator at an assigned workspace within the facility; and detect a set of objects (e.g., equipment units) in the particular frame handled by the operator at the workspace during performance of the primary instructional block.

Accordingly, the computer system can then: detect deviations (or errors) between the set of objects handled by the operator depicted in the live video feed and the manifest of objects corresponding to approved objects within the facility for performing the primary instructional block; in response to detecting the deviation, generate a prompt for the operator to review the set of objects at the assigned workspace prior to proceeding with performance of the primary instructional block; and present the prompt to the operator, such as at an operator device associated with the operator. In one example, the computer system can, based on visual features extracted from a particular frame in the live video feed: identify a primary 250-milliliter flask and a secondary 250-milliliter flask handled by the operator; and detect a deviation between a 500-milliliter flask specified in the object manifest for the primary instructional block and the primary 250-milliliter flask and secondary 250-milliliter flask detected in the live video feed.

In another implementation, the computer system can: access a live video feed, such as from an optical sensor mounted at a headset device associated with the operator and/or mounted to an autonomous cart proximal the operator depicting the operator performing steps of the primary instructional block; extract a set of visual features across a set of frames in the live video feed depicting the operator at an assigned workspace within the facility; and track motions and/or paths of objects handled by the operator based on the set of visual features during performance of the primary instructional block. The computer system can then: detect deviation between an object path for a particular object tracked in the live video feed and a target object path for the particular object recorded for previous instances of the digital procedure at the facility; and correlate the deviation to a particular risk event (e.g., spill event, fire event) proximal the workspace based on the object path for the application object. For example, the computer system can: interpret a deviation corresponding to a flask (e.g., measuring flask) falling proximal the workspace and spilling contents (e.g., hazardous liquids) across the floor of the facility; and correlate the deviation to a spill event associated with the current instance of the primary instructional block performed by the operator. Additionally or alternatively, the computer system can: leverage a suite of sensors (e.g., temperature sensors, pressure sensors, proximity sensors) arranged proximal the operator to interpret the deviation in the current instance of the digital procedure performed by the operator.

In another implementation, the computer system can access the primary live video feed from an optical sensor coupled to an operator device (e.g., a headset) that the operator manipulates during performance of the primary instructional block involving a primary equipment unit at the workspace. The computer system can then: select a primary frame, in the live video feed, that depicts a display of the primary equipment unit in response to the display falling within a field of view of the optical sensor; extract a primary value displayed by the primary equipment unit from the primary frame; and detect the deviation from the primary instruction in response to the primary value exceeding a threshold deviation from a target value defined by the primary instructional block.

Therefore, the computer system can: maintain real-time contextual awareness of objects (e.g., equipment units) handled by the operator during performance of the digital procedure by the operator within the facility; and, in response to detecting a deviation between a current instance of the digital procedure performed by the operator and previous instances of the digital procedure at the facility, notify the operator of the deviation in order to enable the operator to recover from the deviation.

### 13. Presenting the Recovery Block

Block S170 of the method S100 recites, during operation of the primary instructional block by the operator and in response to detecting the primary error in the primary live video feed, serving a primary prompt to the operator to suspend performance of the primary instructional block and to complete the primary recovery block.

Generally, in Block 170, the computer system can: prompt the operator to suspend performance of the primary instructional block to reduce likelihood of an adverse procedural outcome of the primary instructional block that results from the primary error; and present the recovery block to the operator to instruct and guide the operator in resolving the primary error and restoring procedural conditions of the digital procedure to increase likelihood of the target procedural outcome upon completion of the primary instructional block.

In one implementation, the computer system can: access a minimum guidance specification associated with an operator performing the primary instructional block; and present the primary recovery block in a primary preemptively-generated format (e.g., a text format) at an operator device (e.g., an augmented reality headset, a tablet) associated with the operator. Additionally, in response to selection of additional guidance by the operator for completion of the primary instructional block, the computer system can present the primary recovery block in a secondary preemptively-generated format (e.g., a visual format) at the operator device associated with the operator. In one example, the computer system can: present preemptively-generated textual instructions for performing the primary recovery block with a bio-reactor at the facility; and/or render a preemptively-generated annotated visual image to guide the operator in completion of the primary recovery block.

Therefore, rather than presenting general recovery instructions from a static database that potentially fail to resolve a particular error by the operator and/or rather than requiring the operator to manually search for a recovery pathway for a primary error, the computer system can: maintain contextual awareness of a predicted error by the operator during performance of the digital procedure; and, in response to detecting the predicted error during performance of the digital procedure, autonomously present a tailored recovery block that resolves this error for successful completion of the digital procedure.

### 14. Variation: Real-Time Recovery

In one variation, Blocks S160, S162, and S164 of the method S100 recite, during performance of a primary instructional block, in the sequence of instructional blocks in the digital procedure, by an operator within the facility: accessing a primary live video feed, captured by an optical sensor, depicting performance of the primary instructional block by the operator; detecting a primary deviation from the primary instructional block by the operator in the primary live video feed; and, based on the primary deviation, predicting a primary anticipated procedural outcome expected upon completion of the primary instructional block by the operator.

Generally, in Blocks S160, S162, and S164, during performance of a current instance of the digital procedure by the operator, the computer system can: as described above, detect a real-time deviation from the digital procedure by the operator; predict an adverse procedural outcome expected upon completion of the digital procedure based on this real-time deviation; and autonomously generate a recovery block that reduces a difference between this adverse procedural outcome and a target procedural outcome (e.g., a target batch yield) defined in the digital procedure. More specifically, the computer system can: access a live video feed captured by an optical sensor and depicting real-time performance of the current instance of the digital procedure; track procedural conditions (e.g., operator actions, manufacturing input parameters) depicted in the primary live video feed; and, based on differences between these procedural conditions and target procedural conditions defined in the digital procedure, predict a procedural outcome expected upon completion of the digital procedure.

Thus, the computer system can repeat the steps and processes described above to, in real time: generate a recovery block (or a recovery pathway) that reduces a difference between the procedural outcome and the target procedural outcome; and prompt the operator to perform this recovery block for successful completion of the digital procedure.

### 14.1 Real-Time Prediction of Procedural Outcomes

In one implementation, the computer system can: correlate the primary deviation with a set of manufacturing inputs defined in the primary instructional block; access a primary set of parameters—corresponding to the set of manufacturing inputs—recorded during performance of the primary instructional block by the operator; and predict a primary anticipated batch yield, expected upon completion of the primary instructional block by the operator, based on a difference between the set of parameters and a target set of parameters of the set of manufacturing inputs defined in the primary instructional block. The computer system can then, based on a primary set of natural language signals in the primary instructional block, generate the primary recovery block predicted to shift the primary anticipated batch yield toward a target batch yield defined in the primary instructional block.

In one example, the computer system can: extract a primary set of features from the primary live video feed; identify a primary equipment unit depicted in the primary live video feed based on the primary set of features; and, in response to the primary equipment unit deviating from a secondary equipment unit specified in the primary instructional block, detect the primary deviation from the primary instructional block by the operator. The computer system can then: access a historical record of instances of digital procedures performed by the operator at the facility; and, based on previous instances of instructional blocks completed by the operator with the primary equipment unit represented in the historical record (e.g., previous errors and corresponding outcomes), predict the primary anticipated procedural outcome expected upon completion of the primary instructional block by the operator with the primary equipment unit.

In this example, the computer system can then access a manual associated with the primary equipment unit. Accordingly, based on natural language signals in the primary instructional block and the manual, the computer system can generate the primary recovery block predicted to reduce a difference between: the primary anticipated procedural outcome expected upon completion of the primary instructional block by the operator with the primary equipment unit; and the target procedural outcome expected upon completion of the primary instructional block with the secondary equipment unit specified in the primary instructional block.

Therefore, during real-time performance of an instance of the digital procedure by the operator, the computer system can generate a recovery block to reduce likelihood of failure for the instance of the digital procedure.

### 14.1.1 Predicting Batch Yield

In another implementation, the computer system can: calculate a correlation between the primary deviation and a primary procedural risk associated with performance of the primary instructional block; and, in response to the correlation exceeding a threshold correlation, predict a primary risk event (e.g., a hazard material exposure, a combustion event) expected upon completion of the primary instructional block by the operator. The computer system can then, based on the primary set of natural language signals in the primary instructional block, generate the primary recovery block predicted to mitigate the primary risk event. For example, the computer system can generate the primary recovery block that instructs and guides the operator in: retrieving safety materials to mitigate exposure to the predicted risk event; and/or modifying parameters of manufacturing inputs of the digital procedure to mitigate development of the predicted risk event.

Thus, the computer system can: monitor developing exposure of the operator to a procedural risk during real-time performance of the digital procedure by the operator; generate a recovery block (or recovery pathway) that mitigates the exposure of the operator to the procedural risk; and present this recovery block to the operator in real time for successful completion of the digital procedure.

### 14.2 Real-Time Additional Guidance

In one implementation, during real-time performance of the digital procedure by the operator, the computer system can: generate the primary recovery block in a primary format (e.g., a text format); and generate the primary recovery block in a secondary format (e.g., a visual format, an audio format, an augmented reality format) different from the primary format. In this implementation, the computer system can: in response to initialization of the primary recovery block, present the primary recovery block in the primary format at the operator device associated with the operator; and, during performance of the primary recovery block and in response to selection of the operator for additional guidance for completion of the primary recovery block, present the primary recovery block in the secondary format at the operator device associated with the operator.

In another implementation, during real-time performance of the digital procedure by the operator, the computer system can: receive a secondary prompt from the operator device—associated with the operator—requesting additional guidance for completion of the primary recovery block; serve the secondary prompt to a procedure guidance model configured to generate visual media for the primary recovery block based on a set of natural language signals in the secondary prompt; receive, from the procedure authoring model, the visual media; and render the visual media at the operator device.

Therefore, rather than retrieving pre-defined guidance to guide operators in completion of the digital procedure, the computer system can generate real-time guidance tailored to resolve a particular real-time defect during performance of the digital procedure.

### 14.3 Iterative Real-Time Recovery

In one implementation, the computer system can iteratively repeat the steps and processes described above to sequentially generate recovery blocks (or recovery pathways)—responsive to sequential real-time deviations from the digital procedure by the operator—to maintain procedural continuity during performance of the digital procedure.

In one example, during performance of the primary instructional block by the operator, the computer system can: access a secondary live video feed captured by the optical sensor and depicting performance of the primary recovery block by the operator; detect a secondary deviation from the primary recovery block by the operator in the secondary live video feed; and, based on the secondary deviation, predict a secondary anticipated procedural outcome expected upon completion of the primary recovery block by the operator.

In this example, in response to the secondary anticipated procedural outcome exceeding the threshold deviation from the target procedural outcome, the computer system can: generate a secondary recovery block predicted to shift the secondary anticipated procedural outcome toward the target procedural outcome defined in the primary instructional block; and serve a secondary prompt to the operator to suspend performance of the primary instructional block and complete the secondary recovery block. Accordingly, in response to an actual procedural outcome following completion of the secondary recovery block falling within the target procedural outcome, the computer system can serve an additional prompt to the operator to complete a secondary instructional block in the sequence of instructional blocks in the digital procedure.

Therefore, the computer system can sequentially generate recovery blocks during performance of the digital procedure by the operator in order to sequentially drive an anticipated procedural outcome of the digital procedure toward a target procedural outcome.

### 14.4 Real-Time Detection of Non-Operable Equipment Units

In one implementation, during performance of the primary instructional block by the operator, the computer system can: detect non-operability of a primary equipment unit specified for performance of the secondary instructional block following the primary instructional block in the digital procedure; identify a secondary equipment unit, located within the facility, that exhibits operational characteristics compatible with requirements of the secondary instructional block; and assign the secondary equipment unit for performance of the secondary instructional block to maintain continuous procedural flow despite equipment failure or maintenance requirements. For example, the computer system can: extract a temperature reading—exceeding a target operational threshold—from a live video feed depicting an analog temperature gauge on a non-networked incubator that indicates non-operability for cell culture incubation; and scan additional live video feeds to identify an alternative incubator with an operational status, such as displaying a temperature within a target procedural range.

The computer system can then: generate an alternative instructional block to replace the secondary instructional block and predicted to yield a target procedural outcome of the secondary instructional block; and, following completion of the primary instructional block, present the alternative instructional block to the operator instead of the secondary instructional block in the digital procedure. Therefore, the computer system can: dynamically reroute digital procedures to alternative equipment units within the facility in real-time to maintain procedural continuity and reduce equipment downtime within the facility.

### 14.5 Real-Time Procedural Incompatibility

In one implementation, during performance of the primary recovery block by the operator, the computer system can: detect a procedural incompatibility between the secondary instructional block following the primary instructional block and a procedural outcome resulting from operator completion of the primary recovery block; characterize the procedural incompatibility by identifying conflicts between parameters and/or procedural conditions defined in the primary recovery block and operational requirements of the secondary instructional block; and generate an alternative instructional block configured to reconcile the procedural incompatibility, thereby enabling continuous procedural flow within target procedural conditions.

### 15. Disclaimer

The computer systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can include a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

1. A method comprising:
accessing a digital procedure comprising a sequence of instructional blocks performable within a facility; and
during performance of a first instructional block, in the sequence of instructional blocks in the digital procedure, by an operator within the facility:
accessing a first live video feed, captured by an optical sensor, depicting performance of the first instructional block by the operator;
detecting a first deviation from the first instructional block by the operator in the first live video feed;
based on the first deviation, predicting a first anticipated procedural outcome expected upon completion of the first instructional block by the operator; and
in response to the first anticipated procedural outcome exceeding a threshold deviation from a target procedural outcome:
based on a first set of natural language signals in the first instructional block, generating a first recovery block predicted to shift the first anticipated procedural outcome toward the target procedural outcome defined in the first instructional block; and
serving a prompt to the operator to:
suspend performance of the first instructional block; and
complete the first recovery block.

2. The method of claim 1:
wherein predicting the first anticipated procedural outcome comprises:
correlating the first deviation with a set of manufacturing inputs defined in the first instructional block;
accessing a first set of parameters, corresponding to the set of manufacturing inputs, recorded during performance of the first instructional block by the operator; and
based on a difference between the set of parameters and a target set of parameters of the set of manufacturing inputs defined in the first instructional block, predicting a first anticipated batch yield, expected upon completion of the first instructional block by the operator; and
wherein generating the first recovery block comprises, based on the first set of natural language signals in the first instructional block, generating the first recovery block predicted to shift the first anticipated batch yield toward a target batch yield defined in the first instructional block.

3. The method of claim 1:
wherein predicting the first anticipated procedural outcome comprises:
calculating a correlation between the first deviation and a first procedural risk associated with performance of the first instructional block; and
in response to the correlation exceeding a threshold correlation, predicting a first anticipated risk event expected upon completion of the first instructional block by the operator; and
wherein generating the first recovery block comprises, based on the first set of natural language signals in the first instructional block, generating the first recovery block predicted to mitigate the first anticipated risk event.

4. The method of claim 1:
wherein generating the first recovery block comprises:
based on the first set of natural language signals in the first instructional block, generating a first script instructing a procedure authoring model to:
generate textual instructions, performable by the operator, predicted to reduce the difference between the first anticipated procedural outcome and the target procedural outcome;
serving the script to the procedure authoring model for execution; and
receiving, from the procedure authoring model, the textual instructions; and
further comprising, during performance of the first recovery block by the operator, presenting the textual instructions at an operator device associated with the operator.

5. The method of claim 1, further comprising, during performance of the first recovery block by the operator:
receiving a second prompt from an operator device, associated with the operator, requesting additional guidance for completion of the first recovery block;
serving the second prompt to a procedure guidance model configured to generate visual media for the first recovery block based on a second set of natural language signals in the second prompt;
receiving, from the procedure authoring model, the visual media; and
rendering the visual media at the operator device.

6. The method of claim 1:
wherein generating the first recovery block comprises:
accessing a minimum guidance specification associated with the operator;
based on the first set of natural language signals in the first instructional block and a second set of natural language signals in the minimum guidance specification, generating a first script instructing a procedure authoring model to:
generate the first recovery block in a text format corresponding to the minimum guidance specification; and
generate the recovery block in a visual format corresponding to a first guidance specification greater than the minimum guidance specification;
serving the first script to the procedure authoring model for execution; and
receiving, from the procedure authoring model, the first recovery block in the text format and in the visual format; and
further comprising, during performance of the first recovery block by the operator:
presenting the first recovery block in the text format at an operator device associated with the operator; and
in response to selection of additional guidance to complete the first recovery block by the operator, rendering the first recovery block in the visual format at the operator device.

7. The method of claim 1, wherein generating the first recovery block comprises:
based on the first set of natural language signals in the first instructional block and a procedure authoring model, generating an initial recovery block predicted to reduce the difference between the first anticipated procedural outcome and the target procedural outcome;
calculating a first compliance for completion of the initial recovery block at the facility; and
in response to the first compliance falling below a target compliance, based on a second set of natural language signals in the initial recovery block and a procedure compliance model, generating the first recovery block predicted to:
reduce the difference between the first anticipated procedural outcome and the target procedural outcome; and
shift the first compliance toward the target compliance.

8. The method of claim 1:
wherein detecting the first deviation from the first instructional block by the operator in the first live video feed comprises:
extracting a first set of features from the first live video feed;
identifying a first equipment unit depicted in the first live video feed based on the first set of features; and
in response to the first equipment unit deviating from a second equipment unit specified in the first instructional block, detecting the first deviation from the first instructional block by the operator; and
wherein predicting the first anticipated procedural outcome expected upon completion of the first instructional block by the operator comprises:
accessing a historical record of instances of digital procedures performed by the operator at the facility; and
based on previous instances of instructional blocks completed by the operator with the first equipment unit represented in the historical record, predicting the first anticipated procedural outcome expected upon completion of the first instructional block by the operator with the first equipment unit.

9. The method of claim 8, wherein generating the first recovery block comprises:
accessing a manual associated with the first equipment unit; and
based on the first set of natural language signals in the first instructional block and a second set of natural language signals in the manual, generating the first recovery block predicted to shift the first anticipated procedural outcome expected upon completion of the first instructional block by the operator with the first equipment unit toward the target procedural outcome defined in the first instructional block.

10. The method of claim 1, further comprising:
during performance of the first recovery block:
accessing a second live video feed, captured by the optical sensor, depicting performance of the first recovery block by the operator;
detecting a second deviation from the first recovery block by the operator in the second live video feed;
based on the second deviation, predicting a second anticipated procedural outcome expected upon completion of the first recovery block by the operator; and
in response to the second anticipated procedural outcome falling exceeding the threshold deviation from the target procedural outcome:
generating a second recovery block predicted to shift the second anticipated procedural outcome toward the target procedural outcome defined in the first instructional block; and
serving a second prompt to the operator to:
suspend performance of the first instructional block; and
complete the second recovery block; and
in response to an actual procedural outcome following completion of the second recovery block falling within of the target procedural outcome, serving a third prompt to the operator to complete a second instructional block in the sequence of instructional blocks in the digital procedure.

11. The method of claim 1:
wherein generating the first recovery block comprises:
accessing a block library containing verified blocks performable within the facility;
querying the block library for a verified recovery block associated with the first anticipated procedural outcome; and
in response to absence of the verified recovery block in the block library, generating the first recovery block; and
further comprising, in response to an actual procedural outcome falling within the target procedural outcome, following completion of the first recovery block by the operator, aggregating the first recovery block to the block library.

12. The method of claim 1, further comprising:
calculating a procedural compatibility between an anticipated recovery outcome of the first recovery block and a second instructional block in the sequence of instructional blocks in the digital procedure;
in response to the procedural compatibility falling below a compatibility threshold:
generating a second recovery block compatible with the anticipated recovery outcome of the first recovery block and predicted to yield a second anticipated procedural outcome of the second instructional block; and
associating the second recovery block with the second instructional block; and
following completion of the first recovery block by the operator, serving a second prompt to the operator to complete the second recovery block.

13. The method of claim 1, wherein detecting the first deviation comprises:
tracking a first time period during performance of the first instructional block by the operator based on the first live video feed; and
in response to the first time period exceeding a threshold time period defined in the first instructional block, detecting the first deviation from the first instructional block by the operator.

14. The method of claim 1:
wherein accessing the first live video feed comprises accessing the first live video feed from the optical sensor defining a field of view intersecting a workspace occupied by the operator during performance of the first instructional block by the operator; and
wherein detecting the first deviation comprises:
extracting a first set of features from the first live video feed;
based on the first set of features:
identifying a first object depicted in the first live video feed and associated with the first instructional block; and
tracking a first path of the first object; and
in response to the first path of the first object exceeding a threshold deviation from a target path of the first object defined in the first instructional block, detecting the first deviation.

15. The method of claim 1:
wherein accessing the first live video feed comprises accessing the first live video feed from the optical sensor coupled to an operator device, the operator device manipulated by the operator during performance of the first instructional block with a first equipment unit at the facility; and
wherein detecting the first deviation comprises:
in response to a display of the first equipment unit falling within a field of view of the optical sensor, selecting a first frame, in the first live video feed, depicting the display of the first equipment unit;
extracting a first value, presented on the display, from the first frame depicting the display of the first equipment unit; and
in response to the first value exceeding a threshold deviation from a target value defined in the first instructional block, detecting the first deviation.

16. A method comprising:
accessing a digital procedure comprising a sequence of instructional blocks performable within a facility; and
during performance of a first instructional block, in the sequence of instructional blocks in the digital procedure, by an operator within the facility:
accessing a first live video feed, captured by an optical sensor, depicting performance of the first instructional block by the operator;
detecting a first deviation from the first instructional block by the operator in the first live video feed;
based on the first deviation, predicting a first anticipated batch yield expected upon completion of the first instructional block by the operator; and
in response to the first anticipated batch yield falling outside of a target batch yield:
based on a first set of natural language signals in the first instructional block, generating a first recovery block predicted to reduce a difference between the first anticipated batch yield and the target batch yield defined in the first instructional block; and
serving a first prompt to the operator to:
suspend performance of the first instructional block; and
complete the first recovery block.

17. The method of claim 16, wherein generating the first recovery block comprises:
based on the first set of natural language signals in the first instructional block, generating a first script instructing a procedure authoring model to:
generate textual instructions, performable by the operator, predicted to reduce the difference between the first anticipated batch yield and the target batch yield defined in the first instructional block;
serving the first script to the procedure authoring model for execution; and
receiving, from the procedural authoring model, a response specifying the textual instructions.

18. The method of claim 16, further comprising, during performance of the first recovery block by the operator:
receiving a second prompt from an operator device, associated with the operator, requesting additional guidance for completion of the first recovery block;
serving the second prompt to a procedure authoring model configured to generate visual media for the first recovery block based on a second set of natural language signals in the second prompt;
receiving, from the procedure authoring model, the visual media; and
rendering the visual media at the operator device.

19. The method of claim 16, wherein predicting the first anticipated batch yield comprises:
correlating the first deviation with a set of manufacturing inputs defined in the first instructional block;
accessing a first set of parameters, corresponding to the set of manufacturing inputs, recorded during performance of the first instructional block by the operator; and
predicting the first anticipated batch yield based on differences between the first set of parameters recorded during performance of the first instructional block by the operator and a target set of parameters of the set of manufacturing inputs defined in the first instructional block.

20. A method comprising:
accessing a digital procedure performable within a facility; and
during performance of the digital procedure by an operator within the facility:
accessing a data stream representing performance of the digital procedure by the operator;
detecting a deviation from the digital procedure in the data stream;
based on the deviation, predicting an anticipated batch yield expected upon completion of the digital procedure by the operator; and
in response to the anticipated batch yield falling outside of a target batch yield:
based on natural language signals in the digital procedure, generating recovery instructions predicted to reduce a difference between the anticipated batch yield and the target batch yield defined in the digital procedure; and
serving a prompt to the operator to:
suspend performance of the digital procedure; and
complete the recovery instructions.
